(19) United States
(12) Patent Application Publication
(10) Pub. No.: US 2024/0220582 A1
(43) Pub. Date: Jul. 4, 2024

(54) Determining a Value for a Digital Signal Processing Component Based on Input Data Corresponding to Classes

(71) Applicant: Edge Impulse Inc., San Jose, CA (US)

(72) Inventors: Alexander William Elium, Camarillo, CA (US); Yan Li, Victoria BC (CA)

(21) Appl. No.: 18/091,427

(22) Filed: Dec. 30, 2022

(51) Int. Cl. G06F 18/22; G06F 18/2431; G06N 20/00

(52) U.S. Cl. CPC G06F 18/22; G06F 18/2431; G06N 20/00

(57) ABSTRACT

A system may receive input data corresponding to classes. The system may determine a value of a parameter for a digital signal processing (DSP) component based on the input data. The DSP component may control digital signal processing of the input data to generate features for a machine learning model to identify the classes. The value may be determined from a set of candidate values based on applying an optimization function associated with the parameter. In some implementations, the optimization function may measure a distance between vectors calculated by a DSP function implemented by the DSP component. In some implementations, the optimization function may compare spectral energies at multiple frequencies calculated by a DSP function implemented by the DSP component.

### TECHNICAL FIELD

This disclosure relates generally to machine learning and, more specifically, to determining a value of a parameter for a digital signal processing (DSP) component based on input data corresponding to classes.

### BACKGROUND

Machine learning, or artificial intelligence, refers to a system that uses data to perform tasks. A machine learning model may be built for a system based on training data (e.g., a dataset). The machine learning model may then be deployed to make predictions (e.g., predictions that an application can use to help guide decisions, such as predictions for image or sound classification), to generate data, and/or to transform data.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a block diagram of an example of a system for facilitating configuration and deployment of a pipeline.

FIG. 2 is a block diagram of an example internal configuration of a computing device for facilitating configuration and deployment of a pipeline.

FIG. 3 is a block diagram of an example of a system for configuring a pipeline including a signal processing component and a machine learning component.

FIG. 4 is an illustration of an example of a graphical user interface (GUI) indicating data acquired from data source(s).

FIG. 5 is an illustration of an example of a GUI indicating configuration of a pipeline.

FIG. 6 is an illustration of an example of a GUI indicating configuration of a signal processing component of a pipeline.

FIG. 7 is an illustration of an example of a GUI indicating configuration of a machine learning component of a pipeline.

FIG. 8 is an illustration of an example of a GUI indicating performances of multiple configurations of a pipeline.

FIG. 9 is an illustration of an example of a GUI indicating multiple configurations of a pipeline.

FIG. 10 is an illustration of an example of a GUI indicating testing of a configuration of a pipeline.

FIG. 11 is an illustration of an example of a GUI indicating deployment of a configuration of a pipeline to a library.

FIG. 12 is an illustration of an example of a GUI indicating deployment of a configuration of a pipeline to a device.

FIG. 13 is an illustration of an example of a GUI indicating deployment of a configuration of a pipeline to a computer or a mobile phone.

FIG. 14 is a flow chart of an example of a process for configuring a pipeline including a signal processing component and a machine learning component.

FIG. 15 is a block diagram of an example of another system for configuring a pipeline including a signal processing component and a machine learning component.

FIG. 16 is a block diagram of an example of a system for determining a value of a parameter for a DSP component based on input data corresponding to classes.

FIG. 17 is a diagram of an example of a feature space.

FIG. 18 is an illustration of an example of a GUI indicating an interactive view for determining a value of a parameter based on input data corresponding to classes.

FIG. 19 is an illustration of an example of a GUI indicating a feature space.

FIG. 20 is a diagram of an example of a graph with differences of spectral energies.

FIG. 21 is a diagram of example of another graph with differences of spectral energies.

FIG. 22 is a flow chart of an example of a technique for determining a value of a parameter for a DSP component based on input data corresponding to classes.

FIG. 23 is a flow chart of an example of a technique for determining a value of a parameter and/or a DSP function.

### DETAILED DESCRIPTION

Embedded machine learning permits an electronic device, such as a microcontroller, to implement a machine learning model to make predictions (e.g., that an application can use to help guide decisions), to generate data, and/or to transform data. For example, a device with embedded machine learning may receive a sample of data (e.g., input from a sensor) and may use a machine learning model to predict a result based on the sample without accessing software in the cloud. However, there are different ways a machine learning model may be configured for a given application. For example, the machine learning model may include an artificial neural network (or simply a “neural network”), and hyperparameters associated with the neural network may be configured in different ways to achieve different levels of accuracy and/or inference times.

Additionally, there may be constraints associated with a given application. For example, a machine learning model used to predict the busyness of a shopping center might tolerate a greater inference time (e.g., an amount of time for the machine learning model to process input data and produce output data, such as a prediction) than a machine learning model used to predict the movement of an unmanned aerial vehicle (UAV) that may be in flight. Further, there are different devices that could be used when implementing a machine learning model. For example, one device might be more complex with a processor that includes a more execution units, a deep learning accelerator, support for floating point (FP) instructions, and instruction and data caches, while another device might be less complex with a processor that includes a fewer execution units, a lack of support for FP instructions, and a lack of instruction and data caches. In some cases, the device that is more complex could have a heterogenous architecture that uses multiple types of processors and instruction sets. Moreover, the different devices might operate at different clock frequencies. Thus, the performance of such devices may vary.

Additionally, implementing the machine learning model on the different devices may involve utilizing different software toolchains, with the more complex devices sometimes involving more complex software in the toolchain that may be difficult for a user to configure. As a result, it may be time consuming and/or difficult for an engineer to configure a machine learning model for a given application and/or a given device, or for an engineer to port a given application onto multiple different devices. It is therefore desirable to implement a machine learning model for a given application and/or a given device while reducing the time and/or the burden associated with the implementation.

Implementations of this disclosure address problems such as these by receiving an input indicating a target device (e.g., a specified microcontroller, board, computer, or mobile phone) and automatically determining the performances of multiple configurations of a pipeline (sometimes referred to as machine learning pipeline or an impulse), based on the target device indicated by the input, for implementing a configuration of the multiple configurations on the target device. The pipeline may include one or more signal processing components (e.g., one or more components implementing a digital signal processing (DSP) algorithm) and one or more machine learning components (e.g., one or more components implementing conditional logic, a neural network, a heuristic algorithm, or other learning algorithm or classifier). The one or more signal processing components and the one or more machine learning components may be connected to one another in various ways.

A configuration of the pipeline may include one or more parameters for configuring the signal processing component (e.g., settings that affect signal processing calculations, such as a particular DSP algorithm or noise floor) and/or the machine learning component (e.g., settings that affect machine learning, such as hyperparameters including neural network topology, size, or training). Configurations of the multiple configurations may vary in the one or more parameters that are used, and therefore may vary in configurations of the one or more signal processing components and/or the one or more machine learning components. The performance of a configuration may be determined based on the target device, and the target device may be indicated by the input. For example, the target device may be indicated by a user via selection of the target device from a library of multiple possible target devices. The target device could be, for example, a device (e.g., a microcontroller or board), a computer, or a mobile phone. In some implementations, the target device could comprise a system running in a cloud server. The performance of a configuration may also be determined based on an application constraint (e.g., a targeted latency, accuracy, memory usage, and/or energy usage), and the application constraint may be indicated by an input. For example, the application constraint may be indicated by a user for meeting the needs of a given application (e.g., achieving a shorter inference time for predicting the movement of a UAV).

In some implementations, the performance of a configuration may be determined by calculating a latency (e.g., an inference time), a memory usage (e.g., a random access memory (RAM) and/or a read only memory (ROM) usage), an energy usage (e.g., power consumption), and/or level of accuracy associated with the configuration when implemented on the target device. For example, the latency, or inference time, may be an amount of time for the configuration of the pipeline to process input data and produce output data when the configuration is implemented on a target device; the memory usage may be a peak amount of RAM and/or a peak amount of ROM, measured in kilobytes or megabytes, consumed by the target device when implementing the configuration; the energy usage may be a peak amount of power, measured in watts, consumed by the target device when implementing the configuration; and the accuracy may be a fraction or percentage of predictions that the target device correctly determines when implementing the configuration. In some implementations, the performance (e.g., the latency, memory usage, energy usage, or accuracy) of a configuration may be determined by simulating the target device implementing the configuration (e.g., determining the performance based on characteristics of the target device, such as the architecture of a device). In some implementations, the performance of a configuration may be determined by referencing one or more benchmarks associated with the target device (e.g., predetermined performance data from a look up table or other data structure) and applying the one or more benchmarks to estimate the performance of the configuration when the target device implements the configuration. In some cases, a machine learning model or heuristic algorithm may be used to predict the performance of the configuration based on the one or more benchmarks. This may permit determining the performance more quickly when using benchmarks. In some implementations, the configurations may be ranked based on their performances. In some implementations, the performance of a configuration may be compared to an application constraint (e.g., a targeted latency, accuracy, memory usage, and/or energy usage) indicated by an input. In some implementations, a configuration may be selected, based on the configuration satisfying the application constraint, for implementing the configuration on the target device (e.g., a microcontroller or board implementing a given architecture). In some implementations, the configuration may be implemented on a target device by utilizing a software toolchain for the target device, such as for generating firmware. In some implementations, implementing the configuration on a target device may include determining portions of the pipeline to be implemented on various cores of a heterogenous device, and distributing a computational workload associated with the pipeline across the various cores. In some implementations, a graphical user interface (GUI) may be used when configuring the pipeline.

As a result, a pipeline including one or more signal processing components and one or more machine learning components may be determined for an application and/or a device while reducing the time and/or the burden associated with making the determination. Further, the pipeline may be implemented on a target device while reducing the time and/or the burden associated with utilizing the software toolchain for the target device. Additionally, by determining configurations that include signal processing and machine learning components, trade-offs between signal processing efficiency (e.g., utilization of the signal processing component) and machine learning efficiency (e.g., utilization of the machine learning component) may be achieved.

The DSP component (e.g., a block implementing a DSP function, algorithm, or stage) may be applied to pre-process input data for the machine learning component (e.g., a block implementing a machine learning model) to improve performance (e.g., to improve accuracy of predictions). For example, the DSP component could pre-process the input data based on a DSP function using Mel-filterbank energy (MFE), Mel frequency cepstral coefficients (MFCC), or spectrogram. One or more parameters may be applied by the DSP component that is selected (e.g., used by the DSP function to control the signal processing of the input data), such as parameters corresponding to fast Fourier transform (FFT) length, frame length, frame stride, frequency bands, and a noise floor, applied to MFE function. As a result, the DSP component can generate features, from the input data, that the model can use to generate the output data (e.g., the model can identify classes based on the features, as opposed to identifying classes based on raw data, such as the input data without pre-processing).

However, conventional tools lack an efficient mechanism for determining parameters that may be optimal for a given application, instead relying on the involvement of a skilled engineer for customizing the parameters, or relying on a trial and error approach that includes experimenting with different parameters after training the model. For example, in the trial and error approach, an initial set of parameters may be selected for a DSP component, the model may be trained based on features generated by the DSP component, performance of the model may be determined, and the parameters adjusted to improve performance. This may result in a training and adjusting loop which may be time consuming, and in some cases, still might result in less than optimal performance for an application.

Implementations of this disclosure address problems such as these by a system that selects near optimal values for parameters which may be applied by a DSP component for a given application based on mathematical properties of a dataset associated with the application. The system may use, for example, a greedy algorithm to select the parameters, based on the dataset, before training a machine learning model (e.g., without training the model). This may enable determining the parameters without the involvement of a skilled engineer, and in less time than the trial and error approach. In various implementations, a system may receive input data which may correspond to classes (e.g., samples from the dataset associated with the application). For example, for an application involving a sound classifier configured to predict whether “yes” or “no” was spoken (e.g., the input data in this case being time series audio data), the system could receive a first sample of input data in which “yes” is spoken, corresponding to a first class labeled “yes,” and a second sample of input data in which “no” is spoken, corresponding to a second class labeled “no.” The system may determine a value of a parameter (e.g., FFT length, frame length, frame stride, frequency bands, and a noise floor) for a DSP component (e.g., implementing a DSP function, such as the MFE, MFCC, or spectrogram function) based on the input data. The DSP component may control digital signal processing of the input data to generate features for a machine learning model to identify the classes (e.g., “yes” and “no”). The value may be determined from a set of candidate values based on applying an optimization function associated with the parameter. For example, the parameter could be an FFT length applied to the MFE function, and the value of the FFT length could be determined from a set of candidate FFT lengths based on applying an optimization function associated with FFT length. In some implementations, the value may correspond to a candidate value that maximizes the optimization function. For example, the value may correspond to a candidate value that maximizes a distance between vectors calculated by the DSP component. As a result, the parameter may be determined with increased efficiency, in less time, and/or with near-optimal performance for an application.

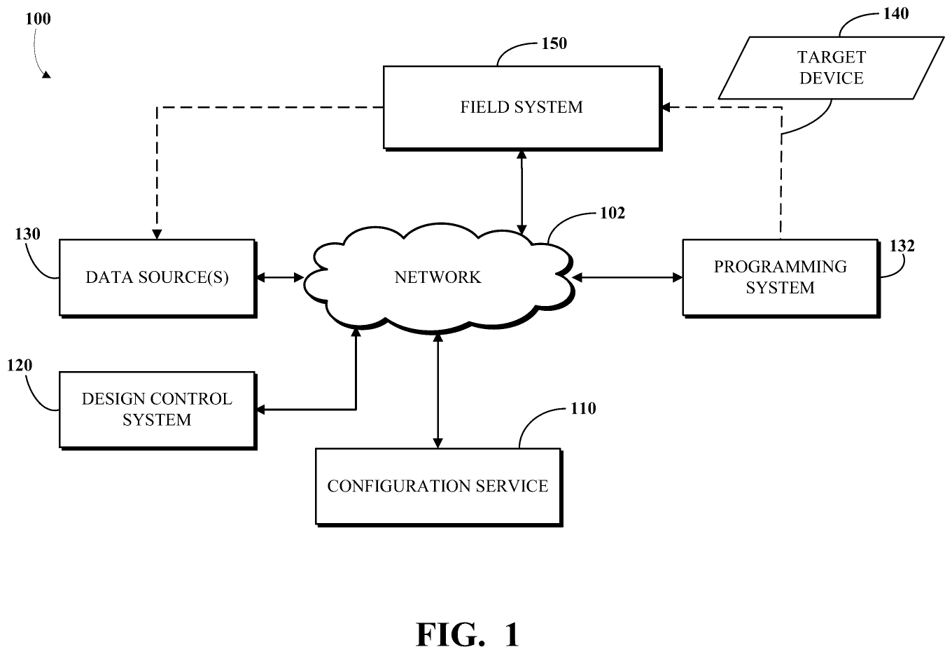

FIG. 1 is a block diagram of an example of a system 100 for facilitating configuration and deployment of a pipeline. The system 100 may include a network 102, a configuration service 110 (e.g., a machine learning pipeline or impulse configuration service), a design control system 120, one or more data sources 130, a programming system 132, and/or a field system 150. A user may utilize the design control system 120 to command the configuration service 110 via network communications over the network 102. For example, a user may utilize a web client or a scripting application program interface (API) client that may be implemented by the design control system 120 to command the configuration service 110.

The configuration service 110 may be used to configure a pipeline to be implemented by a target device. The pipeline may include one or more signal processing components and one or more machine learning components that may be connected to one another in various ways. The target device may be indicated by a user, such as by selection of a target device from a library of multiple possible target devices. For example, the user may utilize the design control system 120 to indicate the selection of the target device to the configuration service 110. The target device could be, for example, a device (e.g., a microcontroller or board), a computer, or a mobile phone. In some implementations, the target device could comprise a system running in a cloud server.

The one or more data sources 130 may be used to provide input data (e.g., raw data) to the configuration service 110 via network communications over the network 102. The input data may be used by the configuration service 110 to generate one or more datasets that may be used to configure, train, and/or test a configuration of the pipeline. The one or more data sources 130 could be selected and/or configured by the user via the design control system 120. The one or more data sources 130 could also be configured by the configuration service 110 for transferring the input data from the one or more data sources 130 to the configuration service 110. The one or more data sources 130 may include, for example, one or more servers, computers, mobile phones, or other electronic devices, such as microcontrollers or boards.

The configuration service 110 may deploy a configuration of the pipeline to a target device 140. In some implementations, the target device 140 could be a device, such as a microcontroller or board. The configuration service 110 may communicate with the programming system 132 via network communications over the network 102 to program the target device 140 (e.g., the device). For example, the configuration service 110 may generate software and/or firmware for deploying the configuration of the pipeline. The configuration service 110 may communicate with the programming system 132 to send the software and/or firmware to the programming system 132. The programming system 132 may use the software and/or firmware to program the target device 140 (e.g., the configuration service 110 may generate a binary that the programming system 132 may use to flash, or program the ROM, of the device). Thus, the target device 140, when programmed, may implement a configuration of the pipeline that may be used for machine learning on a target device having constraints (e.g., embedded machine learning).

In some implementations, the target device 140 could be a computer or a mobile phone. The configuration service 110 may communicate with the computer or the mobile phone, via network communications over the network 102, to program the computer or the mobile phone. For example, the configuration service 110 may generate software for deploying the configuration of the pipeline to the computer or the mobile phone. The configuration service 110 may communicate with the computer or the mobile phone to send the software to the computer or the mobile phone for the computer or the mobile phone to execute. Thus, the computer or the mobile phone, when using the software, may implement a configuration of the pipeline that may be used for machine learning on a target having constraints (e.g., embedded machine learning). In some cases, the configuration service 110 may generate software for deploying the configuration of the pipeline to a library. A computer or other device, such as the target device 140, may use the library to implement a configuration of the pipeline.

In some implementations, the target device 140 may be implemented in the field system 150. The field system could be an intelligent device that uses the target device 140 to make predictions that can help guide decisions for an application. For example, the field system 150 could be an edge device, a medical device, a wearable device, or other device including a processor.

In some implementations, the field system 150, implementing the target device 140, may also serve as a data source like the one or more data sources 130. For example, the target device 140 may be used to provide input data to the configuration service 110, via the field system 150 and network communications over the network 102. The configuration service 110 may use the input data from the target device 140, like input data from the one or more data sources 130, to configure, train, and/or test a pipeline implemented by the target device 140 and/or another pipeline to be implemented by another target device.

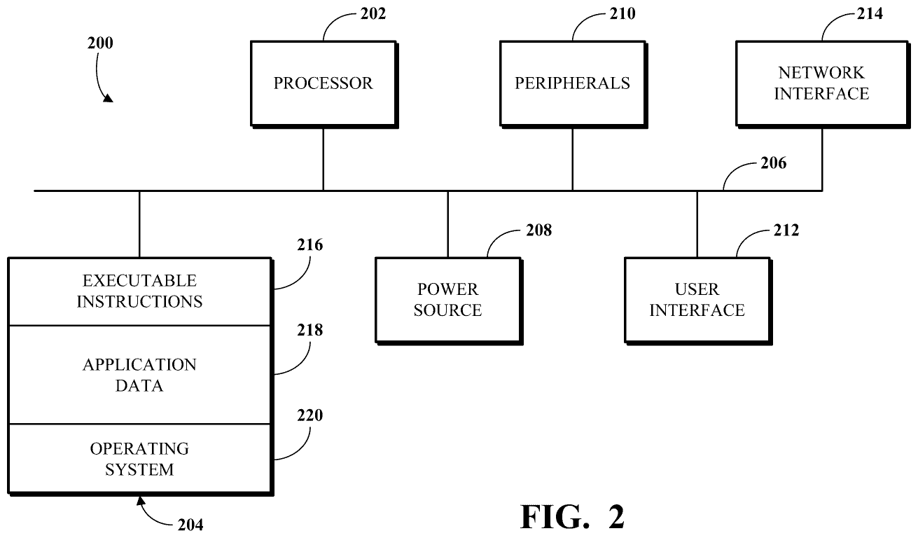

FIG. 2 is a block diagram of an example internal configuration of a computing device 200 for facilitating configuration and deployment of a pipeline. The computing device 200 may implement one or more of the configuration service 110, the design control system 120, the one or more data sources 130, the programming system 132, the target device 140, or the field system 150 shown in FIG. 1.

The computing device 200 includes components or units, such as a processor 202, a memory 204, a bus 206, a power source 208, peripherals 210, a user interface 212, a network interface 214, other suitable components, or a combination thereof. One or more of the memory 204, the power source 208, the peripherals 210, the user interface 212, or the network interface 214 can communicate with the processor 202 via the bus 206.

The processor 202 is a central processing unit, such as a microprocessor, and can include single or multiple processors having single or multiple processing cores. Alternatively, the processor 202 can include another type of device, or multiple devices, configured for manipulating or processing information. For example, the processor 202 can include multiple processors interconnected in one or more manners, including hardwired or networked. The operations of the processor 202 can be distributed across multiple devices or units that can be coupled directly or across a local area or other suitable type of network. The processor 202 can include a cache, or cache memory, for local storage of operating data or instructions.

The memory 204 includes one or more memory components, which may each be volatile memory or non-volatile memory. For example, the volatile memory can be random access memory (RAM) (e.g., a dynamic random access memory (DRAM) module, such as double data rate (DDR) synchronous DRAM). In another example, the non-volatile memory of the memory 204 can be a disk drive, a solid state drive, flash memory, or phase-change memory. In some implementations, the memory 204 can be distributed across multiple devices. For example, the memory 204 can include network-based memory or memory in multiple clients or servers performing the operations of those multiple devices.

The memory 204 can include data for immediate access by the processor 202. For example, the memory 204 can include executable instructions 216, application data 218, and an operating system 220. The executable instructions 216 can include one or more application programs, which can be loaded or copied, in whole or in part, from non-volatile memory to volatile memory to be executed by the processor 202. For example, the executable instructions 216 can include instructions for performing some or all of the techniques of this disclosure. The application data 218 can include user data, database data (e.g., database catalogs or dictionaries), or the like. In some implementations, the application data 218 can include functional programs, such as a web browser, a web server, a database server, another program, or a combination thereof. The operating system 220, when present, can be, for example, Microsoft Windows®, Mac OS X®, or Linux®; an operating system for a mobile device, such as a smartphone or tablet device; or an operating system for a non-mobile device, such as a mainframe computer. For example, a target device that is an embedded device might not have an operating system.

The power source 208 provides power to the computing device 200. For example, the power source 208 can be an interface to an external power distribution system. In another example, the power source 208 can be a battery, such as where the computing device 200 is a mobile device or is otherwise configured to operate independently of an external power distribution system. In some implementations, the computing device 200 may include or otherwise use multiple power sources. In some such implementations, the power source 208 can be a backup battery.

The peripherals 210 includes one or more sensors, detectors, or other devices configured for monitoring the computing device 200 or the environment around the computing device 200. For example, the peripherals 210 can include a geolocation component, such as a global positioning system location unit. In another example, the peripherals can include a temperature sensor for measuring temperatures of components of the computing device 200, such as the processor 202. In some implementations, the computing device 200 can omit the peripherals 210.

The user interface 212 includes one or more input interfaces and/or output interfaces. An input interface may, for example, be a positional input device, such as a mouse, touchpad, touchscreen, or the like; a keyboard; or another suitable human or machine interface device. An output interface may, for example, be a display, such as a liquid crystal display, a cathode-ray tube, a light emitting diode display, virtual reality display, or other suitable display.

The network interface 214 provides a connection or link to a network (e.g., the network 102 shown in FIG. 1). The network interface 214 can be a wired network interface or a wireless network interface. The computing device 200 can communicate with other devices via the network interface 214 using one or more network protocols, such as using Ethernet, transmission control protocol (TCP), internet protocol (IP), power line communication, an IEEE 802.X protocol (e.g., Wi-Fi, Bluetooth, or ZigBee), infrared, visible light, general packet radio service (GPRS), global system for mobile communications (GSM), code-division multiple access (CDMA), Z-Wave, another protocol, or a combination thereof.

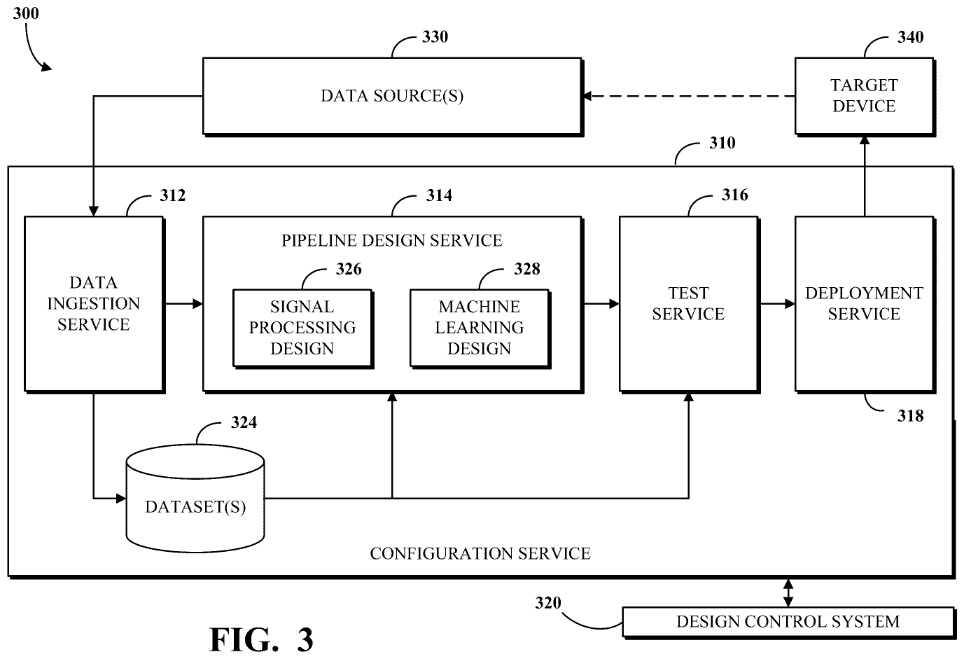

FIG. 3 is a block diagram of an example of a system 300 for configuring a pipeline including a signal processing component and a machine learning component. The system 300 may include a configuration service 310, a design control system 320, one or more data sources 330, and a target device 340 like the configuration service 110, the design control system 120, the one or more data sources 130, and the target device 140 shown in FIG. 1, respectively.

The configuration service 310 may be a software platform instantiated using one or more servers at one or more datacenters. The configuration service 310 may include a data ingestion service 312, a pipeline design service 314, a test service 316, and a deployment service 318. The data ingestion service 312 may receive input data from the one or more data sources 330. The input data may be used by the configuration service 310 to generate one or more datasets that may be used to configure, train, and/or test a configuration of the pipeline. The one or more datasets may be stored by the configuration service 310 in a database 324. The one or more data sources 330 could be selected and/or configured by the user via the design control system 320. The one or more data sources 330 could also be configured by the configuration service 310, such as for transferring the input data from the one or more data sources 330 to the configuration service 310. The one or more data sources 330 may include, for example, one or more servers, computers, mobile phones, or other electronic devices, such as microcontrollers or boards.

The pipeline design service 314 may be used to configure one or more configurations of a pipeline (e.g., a machine learning pipeline or impulse) to be implemented on the target device 340 (e.g., a specified microcontroller, board, computer, or mobile phone). The pipeline design service 314 may utilize a signal processing design service 326 and/or a machine learning design service 328 to configure a configuration of the pipeline. The signal processing design service 326 may be used to configure one or more signal processing components (e.g., one or more components implementing a DSP algorithm) for the pipeline. The machine learning design service 328 may be used to configure one or more machine learning components (e.g., one or more components implementing conditional logic, a neural network, a heuristic algorithm, or other learning algorithm, such as a classifier) for the pipeline. The signal processing components and the machine learning components may be connected to one another in various ways by the pipeline design service 314 (e.g., in series or in parallel). In one example, a signal processing component may be arranged in a first stage to pre-process data, followed by a machine learning component arranged in a second stage in series to process data. In another example, a first signal processing component may be arranged in a first stage to pre-process data, followed by a second signal processing component arranged in a second stage in series to further pre-process data, followed by a machine learning component arranged in a third stage in series to process data (e.g., multiple signal processing components). In another example, a signal processing component may be arranged in a first stage to pre-process data, followed by a first machine learning component arranged in a second stage in series to process data, followed by a second machine learning component arranged in a third stage in series to post-process data (e.g., multiple machine learning components). In some cases, the one or more signal processing components and/or the one or more machine learning components may be connected in parallel. For example, in a first stage, a first signal processing component may pre-process data in a first path and a second signal processing component may pre-process data in a second path, in a second stage, a first machine learning component may process data from the first signal processing component in the first path and a second machine learning component may process data from the second signal processing component in the second path, and in a third stage, a third machine learning component may post-process data from the first machine learning component and the second machine learning component in the second stage. Thus, the pipeline design service 314 may permit one or more signal processing components and one or more machine learning components to be connected to one another in various ways.

Various parameters may be used to configure a configuration of the pipeline. The signal processing design service 326 may determine the parameters for configuring the one or more signal processing components, and the machine learning design service 328 may determine the parameters for configuring the one or more machine learning components. Examples of parameters for configuring a processing component may include selection of a DSP algorithm (e.g., Mel-filterbank energy (MFE), Mel frequency cepstral coefficients (MFCC), or spectrogram), frame length, frame stride, frequency bands, and normalization or noise floor. Examples of parameters for configuring a machine learning component may include selection of a learning process (e.g., conditional logic, neural network, heuristic algorithm, or other learning algorithm, such as a classifier), and hyperparameters, such as number of training cycles, learning rate, validation set size, neural network topology, neural network size, types of layers, and order of layers. For example, parameters for a neural network may configure layers as dense, 1D convolution, or 2D convolution, and/or to reshape, flatten, and/or dropout. In some implementations, the pipeline design service 314 (e.g., the signal processing design service 326 and/or the machine learning design service 328) may determine the parameters based on user input of parameters, the target device 340, an application constraint (e.g., a targeted latency, accuracy, memory usage, and/or energy usage), and/or datasets stored in the database 324. One or more of the user input of parameters, the target device 340, the application constraint, and/or the datasets may be indicated by input from a user, such as via the design control system 320. One or more parameters may be specified and/or modified by a user, such as via the design control system 320.

The test service 316 may be used to test the one or more configurations of the pipeline. In some implementations, the test service 316 may use data from datasets stored in the database 324 to test the or more configurations of the pipeline to generate feedback. For example, the test service 316 may test the one or more configurations with respect to latency (e.g., inference time), level of accuracy of predictions, memory usage (e.g., RAM and/or ROM), and/or energy usage (e.g., power consumption). The test service 316 may provide such feedback to a user, via the design control system 320, so that the user may accept or change a configuration of the pipeline based on the testing. In some implementations, the test service 316 may use the feedback to identify one or more parts of the configuration of the pipeline (e.g., a signal processing component or a machine learning component) to change.

The deployment service 318 may be used to deploy a configuration of the pipeline to the target device 340. The target device 340 may be indicated by a user via the design control system 320. In some implementations, the target device 340 may be indicated by a selection of the target device 340 from a library of multiple possible target devices. The target device 340 could be, for example, a device (e.g., a microcontroller or board), a computer, or a mobile phone. In some implementations, the target device 340 could comprise a system running in a cloud server. The deployment service 318 may utilize a software toolchain, specific to the target device 340, for generating software and/or firmware for deploying the configuration of the pipeline to the target device 340. For example, a software toolchain may include a set of programming tools (e.g., a compiler, linker, libraries, and debugger) provided by a manufacturer or vendor for programming a particular device, library, computer, or mobile phone.

In some implementations, the deployment service 318 may communicate with a programming system (e.g., the programming system 132) to send the software and/or firmware to the programming system for programming the target device 340. For example, the deployment service 318 may generate a binary that may be used to flash, or program the ROM, of a device corresponding to the target device 340. Thus, the target device 340, when programmed, may implement a configuration of the pipeline that may be used for machine learning on a target having constraints, such as in a field system like the field system 150 shown in FIG. 1. For example, the target device 340 could be an embedded device that implements embedded machine learning in the field system 150.

Thus, there may be different ways a pipeline may be configured on the target device 340. Additionally, there may be constraints associated with the target device 340, such as memory usage (e.g., RAM and/or ROM availability by the target device 340) and/or energy usage (e.g., power limitations of the target device 340), and constraints associated with application of the target device 340 in the field, such as latency (e.g., inference time) and/or level of accuracy (e.g., predictions). Further, target devices may differ from one another with respect to implementing the pipeline (e.g., the software toolchains involved to implement a configuration of the pipeline on a target device may differ), with more complex target devices sometimes involving a more complex implementation. Further, target devices may differ from one another with respect to performance (e.g., some target devices may inherently perform better than others, such as devices having more execution units and higher clock frequencies performing better than devices having fewer execution units and lower clock frequencies).

Implementations of this disclosure permit automatically determining the performances of multiple configurations of a pipeline for implementation on the target device 340. The configuration service 310 may receive input, such as selection of the target device 340, selection of application constraints (e.g., a targeted latency, accuracy, memory usage, and/or energy usage), selection of one or more data sources 330, selection of input data, and/or selection of one or more parameters. The input may be provided by a user via the design control system 320. The configuration service 310 may execute to generate multiple configurations of a pipeline based on the input (e.g., selection of the target device 340, the application constraints, the input data, and/or the one or more parameters). The multiple configurations may vary in the parameters that are used, including parameters that may be specified by the user, and therefore may vary in configurations of the one or more signal processing components (e.g., configured by the signal processing design service 326) and/or the one or more machine learning components (e.g., configured by the machine learning design service 328). Thus, the performance of a first configuration of the pipeline that may be implemented on the target device 340 may vary from the performance of a second configuration of the pipeline of the pipeline that may be implemented on the target device 340. The configuration service 310 may execute to determine the performances of the multiple configurations of the pipeline that it determines based on the input (e.g., selection of the target device 340, the application constraints, the input data, and/or the one or more parameters). The performances of the multiple configurations may be determined, for example, by calculating latencies (e.g., inference times), memory usage (e.g., RAM and/or ROM usage), energy usage (e.g., power consumption), and/or levels of accuracy associated with the configurations when implemented on the target device 340.

In some implementations, the performance of a configuration may be determined by simulating the target device 340 implementing the configuration. This may permit determining the performance based on characteristics of the target device 340, such as the particular architecture implemented by the target device 340. For example, simulating the target device 340 may include executing compiled code (e.g., computer instructions) implementing the pipeline on a virtual version of the target device 340. In some implementations, the performance of a configuration may be determined by referencing one or more benchmarks associated with the target device 340 (e.g., predetermined performance data from a look up table or other data structure) and applying the one or more benchmarks to estimate the performance of the configuration when the target device 340 implements the configuration. In some cases, a machine learning model or heuristic algorithm may be used to predict the performance of the configuration based on the one or more benchmarks. This may permit determining the performance more quickly when using benchmarks. In some implementations, the configurations may be ranked based on their performances with their relative rankings displayed to a GUI. In some implementations, the performance of a configuration may be compared to an application constraint (e.g., a targeted latency, accuracy, memory usage, and/or energy usage) indicated by an input and displayed to a GUI. In some implementations, a configuration may be selected, based on the configuration satisfying the application constraint, for implementing the configuration on the target device 340 (e.g., a microcontroller or board implementing a given architecture). In some implementations, the configuration may be implemented on the target device 340 by utilizing a software toolchain for the target device 340, such as for generating software and/or firmware that is specific to the target device 340. In some implementations, implementing the configuration on the target device 340 may include determining portions of the pipeline to be implemented on various cores of a heterogenous device (e.g., a device including multiple types of processors and instruction sets), and may include distributing a computational workload associated with the pipeline across the various cores. In some implementations, a GUI may be used when configuring the pipeline, such as a GUI displayed to a user via the design control system 320.

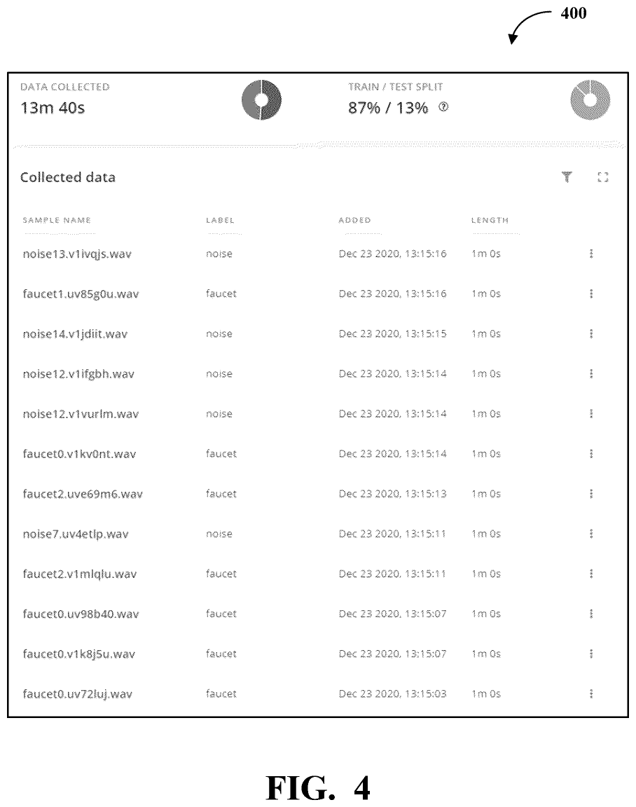

FIG. 4 is an illustration of an example of a GUI 400 indicating data acquired from data source(s) (e.g., the one or more data sources 330). The GUI 400 could be output for display at a user interface like the user interface 212 shown in FIG. 2. For example, the GUI 400 could be output for display to a user at the design control system 320 shown in FIG. 3. The information associated with the GUI 400 may be accessible via an API.

The GUI 400 may indicate data acquired, by the data ingestion service 312, from the one or more data sources 330 shown in FIG. 3. The data acquired (or “collected data”) may comprise input data with associated labels for machine learning. For example, the collected data may include audio files that are labeled “faucet” or “noise” for training a configuration of the pipeline to classify a sound as either “faucet.” indicating a sound of water running from a faucet, or “noise,” indicating a sound other than water running from a faucet. The input data may be processed by the data ingestion service 312 and stored as one or more datasets in the database 324. The data ingestion service 312 may split the input data into a first amount for training the pipeline (e.g., 87%) and a second amount for testing the pipeline (e.g., 13%). In some implementations, the data ingestion service 312 may determine a default for the train/test split, and a user may change the default via the design control system 320.

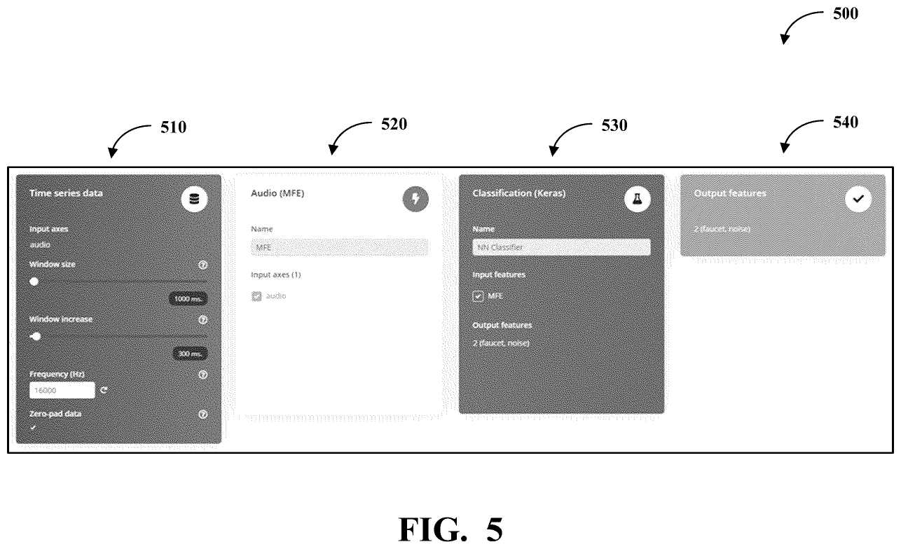

FIG. 5 is an illustration of an example of a GUI 500 indicating a configuration of a pipeline. The GUI 500 could be output for display at a user interface like the user interface 212 shown in FIG. 2. For example, the GUI 500 could be output for display to a user at a design control system like the design control system 320 shown in FIG. 3. The GUI 500 may be used to configure a pipeline (e.g., an impulse) for implementation on a target device (e.g., the target device 340). The information associated with the GUI 500 may be accessible via an API.

An input block 510 may indicate an input configuration, based on parameters, of the input data (e.g., images or time series, such as audio, vibration, or movements) from the one or more data sources (e.g., the one or more data sources 330). The input data may be processed by the data ingestion service 312, to produce one or more datasets, according to the input configuration (e.g., input axes for listing each axis referenced from the training dataset, window size defining the size of the raw features used for the training, window increase to extract multiple overlapping windows from a single sample, and frequency for sampling data). In some implementations, the data ingestion service 312 may determine a default for the input configuration, and the default may be modified by a user via the input block 510. A signal processing block 520 may indicate a signal processing configuration, based on parameters, for the signal processing design service 326. The signal processing configuration may be used by the signal processing design service 326 to generate the one or more signal processing components. In some implementations, the signal processing block 520 may determine a default for the signal processing configuration, and the default may be modified by a user via the signal processing block 520. A machine learning block 530 may indicate a machine learning configuration, based on parameters, for the machine learning design service 328. The machine learning configuration may be used by the machine learning design service 328 to generate the one or more machine learning components. In some implementations, the machine learning design service 328 may determine a default for the machine learning configuration, and the default may be modified by a user via the machine learning block 530. An output block 540 may indicate an output configuration, based on parameters, for the output of the pipeline (e.g., output data, such as classifying a data sample as “faucet.” indicating a sound of water running from a faucet, or “noise,” indicating a sound other than water running from a faucet.). In some implementations, the pipeline design service 314 may determine a default for the output configuration, and the default may be modified by a user via the output block 540.

The GUI 500 may permit one or more signal processing components (e.g., via the signal processing block 520) and the machine learning components (e.g., via the machine learning block 530) to be connected to one another in various ways (e.g., in series or in parallel). In one example, a signal processing component may be arranged in a first stage to pre-process data, followed by a machine learning component arranged in a second stage in series to process data. In another example, a first signal processing component may be arranged in a first stage to pre-process data, followed by a second signal processing component arranged in a second stage in series to further pre-process data, followed by a machine learning component arranged in a third stage in series to process data (e.g., multiple signal processing components). In another example, a signal processing component may be arranged in a first stage to pre-process data, followed by a first machine learning component arranged in a second stage in series to process data, followed by a second machine learning component arranged in a third stage in series to post-process data (e.g., multiple machine learning components). In some cases, the one or more signal processing components and/or the one or more machine learning components may be connected in parallel. For example, in a first stage, a first signal processing component may pre-process data in a first path and a second signal processing component may pre-process data in a second path, in a second stage, a first machine learning component may process data from the first signal processing component in the first path and a second machine learning component may process data from the second signal processing component in the second path, and in a third stage, a third machine learning component may post-process data from the first machine learning component and the second machine learning component in the second stage. Thus, the GUI 500 (e.g., via the pipeline design service 314) may permit one or more signal processing components and one or more machine learning components to be connected to one another in various ways.

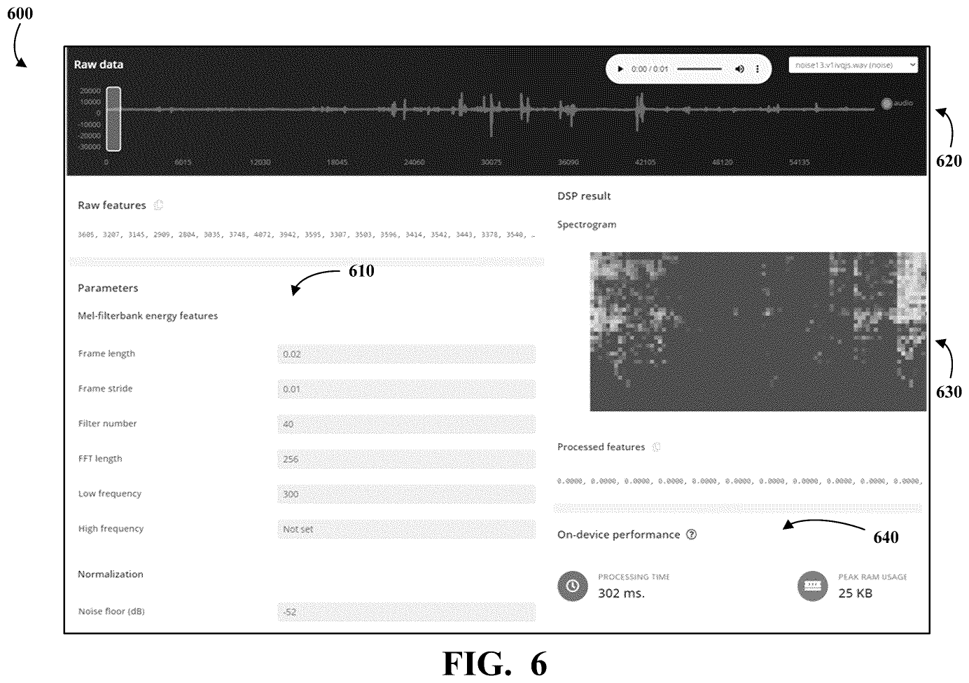

FIG. 6 is an illustration of an example of a GUI 600 indicating a configuration, based on parameters, of a signal processing component of a pipeline. The GUI 600 could be output for display at a user interface like the user interface 212 shown in FIG. 2. For example, the GUI 600 could be output for display to a user at a design control system like the design control system 320 shown in FIG. 3. In some cases, selecting the signal processing block 520 shown in FIG. 5 may cause display of the GUI 600. The information associated with the GUI 600 may be accessible via an API.

The GUI 600 may include parameters 610 for the signal processing design service 326 to generate one or more signal processing components. The parameters 610 may permit selections of a DSP algorithm (e.g., MFE, MFCC, or spectrogram), frame length, frame stride, frequency bands, filter number, fast Fourier transform (FFT) length, low frequency, high frequency, and normalization or noise floor. The signal processing design service 326 may generate a signal processing component based on the parameters 610. A user may change one or more of the parameters 610 in the GUI 600, such as via the design control system 320.

To assist in the configuration, the GUI 600 may permit review of input data (e.g., processed by the data ingestion service 312), and features associated with the input data, via a waveform 620. The GUI 600 may also permit review of signal processing results (e.g., pre-processed data), from the signal processing component as configured, via a signal processing map 630. The GUI 600 may also indicate performance 640 (e.g., processing time and peak memory usage, such as RAM) of the signal processing component as configured. For example, the performance 640 may be determined by the signal processing design service 326, based on input (e.g., selection of the target device 340, the application constraints, the input data, and/or the one or more parameters), via simulations and/or benchmarks.

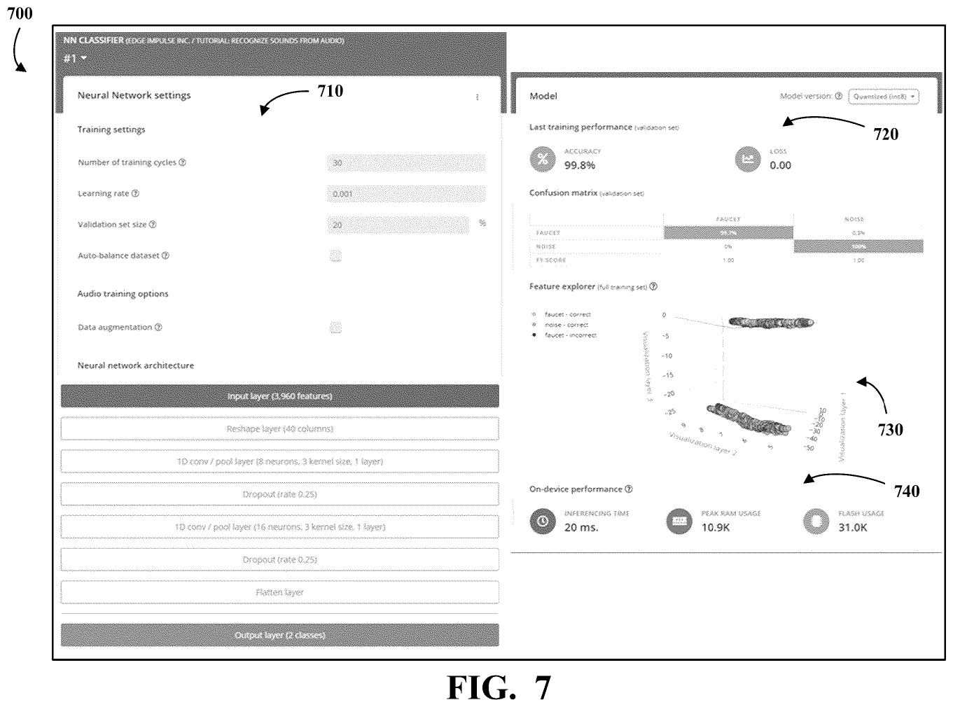

FIG. 7 is an illustration of an example of a GUI 700 indicating a configuration, based on parameters, of a machine learning component of a pipeline. The GUI 700 could be output for display at a user interface like the user interface 212 shown in FIG. 2. For example, the GUI 700 could be output for display to a user at a design control system like the design control system 320 shown in FIG. 3. In some cases, selecting the machine learning block 530 shown in FIG. 5 may cause display of the GUI 700. The information associated with the GUI 700 may be accessible via an API.

The GUI 700 may include parameters 710 for the machine learning design service 328 to generate one or more machine learning components. The parameters 710 may permit selections of a learning process (e.g., conditional logic, neural network, heuristic algorithm, or other learning algorithm, such as a classifier), and hyperparameters, such as number of training cycles, learning rate, validation set size, neural network topology, neural network size, types of layers, and order of layers. The machine learning design service 328 may generate a machine learning component based on the parameters 710. A user may change one or more of the parameters 710 in the GUI 700, such as via the design control system 320.

To assist in the configuration, the GUI 700 may permit review of machine learning results 720 (e.g., processed data), from the machine learning component as configured, such as by displaying a determined level of accuracy, a confusion matrix, and a machine learning map 730. The GUI 700 may also indicate performance 740 (e.g., inference time and peak memory usage, such as ROM and/or RAM) of the machine learning component as configured. For example, the performance 740 may be determined by the machine learning design service 328, based on input (e.g., selection of the target device 340, the application constraints, the input data, and/or the one or more parameters), via simulations and/or benchmarks.

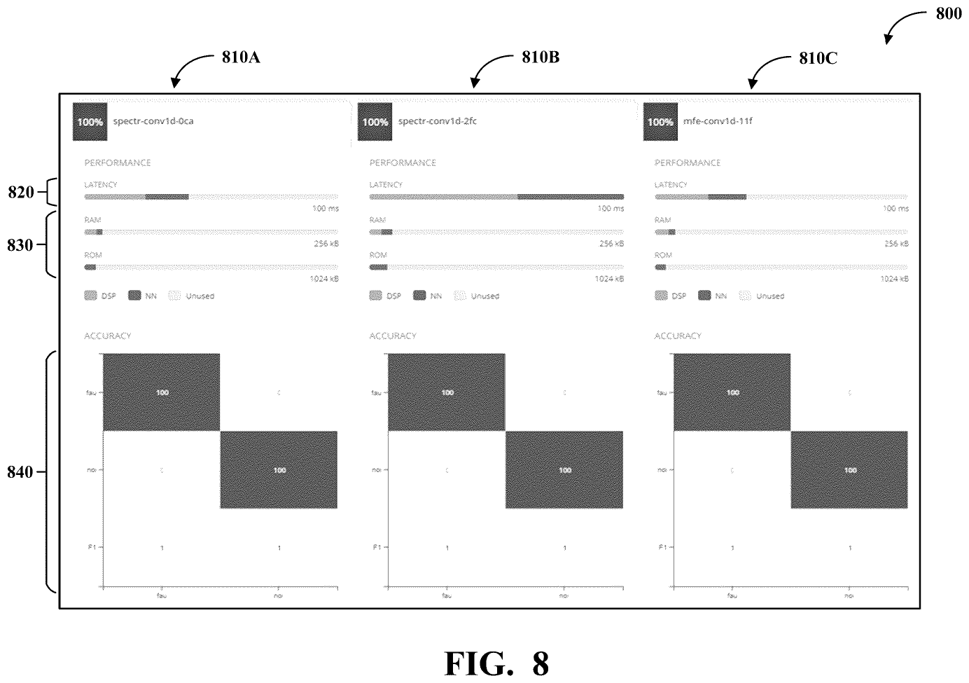

FIG. 8 is an illustration of an example of a GUI 800 indicating performances of multiple configurations of a pipeline. The GUI 800 could be output for display at a user interface like the user interface 212 shown in FIG. 2. For example, the GUI 800 could be output for display to a user at a design control system like the design control system 320 shown in FIG. 3. The information associated with the GUI 800 may be accessible via an API.

The GUI 800 may indicate performances, such as performances 810A through 810C. The performances 810A through 810C may be associated with varying configurations of the pipeline (e.g., varying based on parameters). For example, the performance 810A may be associated with a first configuration of the pipeline (e.g., a configuration of the pipeline including a signal processing component with a spectrogram algorithm and a machine learning component with a neural network having two 1D convolution layers and data augmentation); the performance 810B may be associated with a second configuration of the pipeline (e.g., a configuration of the pipeline including a signal processing component with a spectrogram algorithm and a machine learning component with a neural network having four 1D convolution layers and no data augmentation); and the performance 810C may be associated with a third configuration of the pipeline (e.g., a configuration of the pipeline including a signal processing component with an MFE algorithm and a machine learning component with a neural network having three 1D convolution layers and data augmentation). The performances 810A through 810C may be determined by the pipeline design service 314, including based on input from user (e.g., selection of the target device 340, the application constraints, the input data, and/or the one or more parameters), such as via simulation or benchmarks.

Each of the performances 810A through 810C may indicate a latency 820 (e.g., an inference time), a memory usage 830 (e.g., a RAM usage and a ROM usage), and a level of accuracy 840, for their respective configurations when implemented on the target device 340. In some implementations, the performances 810A through 810C may also indicate an energy usage when implemented on the target device 340. In some implementations, the performances 810A through 810C (e.g., the latency 820, the memory usage 830, the energy usage, or the accuracy 840) of the configurations may be determined by simulating the target device 340 implementing each of the configurations (e.g., determining the performances based on characteristics of the target device 340, such as the architecture of a device). In some implementations, the performances 810A through 810C of the configurations may be determined by referencing one or more benchmarks associated with the target device 340 (e.g., predetermined performance data from a look up table or other data structure) and applying the one or more benchmarks to estimate the performance of each configuration when implemented on the target device 340. In some cases, a machine learning model or heuristic algorithm may be used to predict the performance of a configuration based on the one or more benchmarks. This may permit determining performances more quickly when using benchmarks. In some implementations, the configurations may be ranked based on their performances (e.g., indicating a configuration with a higher level of accuracy before indicating a configuration with a lower level of accuracy). In some implementations, the performances 810A through 810C may be compared to an application constraint (e.g., a targeted latency, accuracy, memory usage, and/or energy usage) indicated by the input.

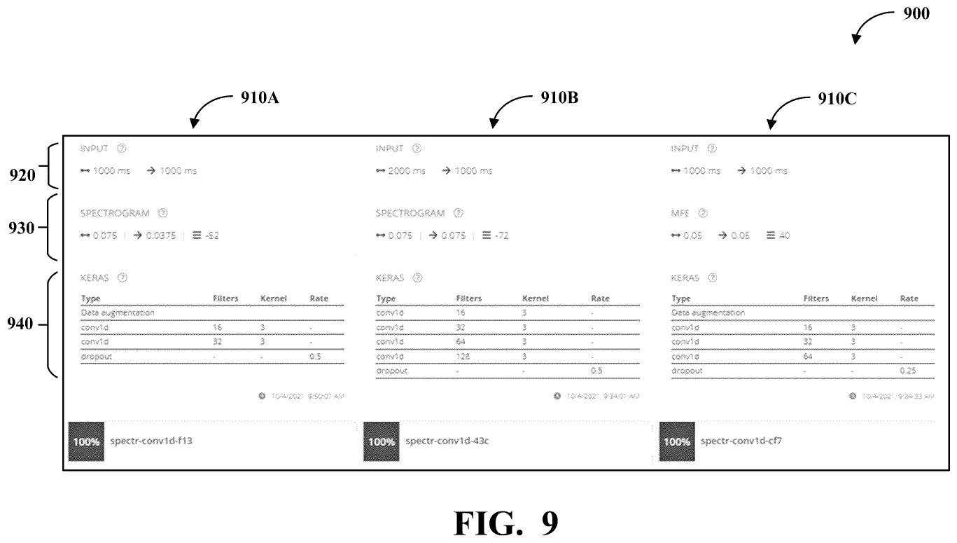

FIG. 9 is an illustration of an example of a GUI 900 indicating multiple configurations of a pipeline. The GUI 900 could be output for display at a user interface like the user interface 212 shown in FIG. 2. For example, the GUI 900 could be output for display to a user at a design control system like the design control system 320 shown in FIG. 3. The information associated with the GUI 900 may be accessible via an API.

The GUI 900 may indicate multiple configurations of a pipeline, such as configurations 910A through 910C. The configurations 910A through 910C may vary based on parameters and may be associated with varying performances of the pipeline, such the performances 810A through 810C. For example, the configuration 910A (e.g., a configuration of the pipeline including a signal processing component with a spectrogram algorithm and a machine learning component with a neural network having two 1D convolution layers and data augmentation) may be associated with the performance 810A; the configuration 910B (e.g., a configuration of the pipeline including a signal processing component with a spectrogram algorithm and a machine learning component with a neural network having four 1D convolution layers and no data augmentation) may be associated with the performance 810B; and the configuration 910C (e.g., a configuration of the pipeline including a signal processing component with an MFE algorithm and a machine learning component with a neural network having three 1D convolution layers and data augmentation) may be associated with the performance 810C. The configurations 910A through 910C may be determined by the pipeline design service 314, including based on input from a user (e.g., selection of the target device 340, the application constraints, the input data, and/or the one or more parameters). For example, the configurations 910A through 910C may be determined by the signal processing design service 326 and the machine learning design service 328. In some implementations, the GUI 900 and the GUI 800 may be displayed in a combined GUI that indicates the relationships between the performances 810A through 810C and, correspondingly, the configurations 910A through 910C.

Each of the configurations 910A through 910C may include indication of an input configuration 920, a signal processing configuration 930, and a machine learning configuration 940. The input configuration 920 may be based on parameters for the input data used by the data ingestion service 312. The signal processing configuration 930 may be based on parameters for the signal processing component used by the signal processing design service 326. The machine learning configuration 940 may be based on parameters for the machine learning component used by the machine learning design service 328.

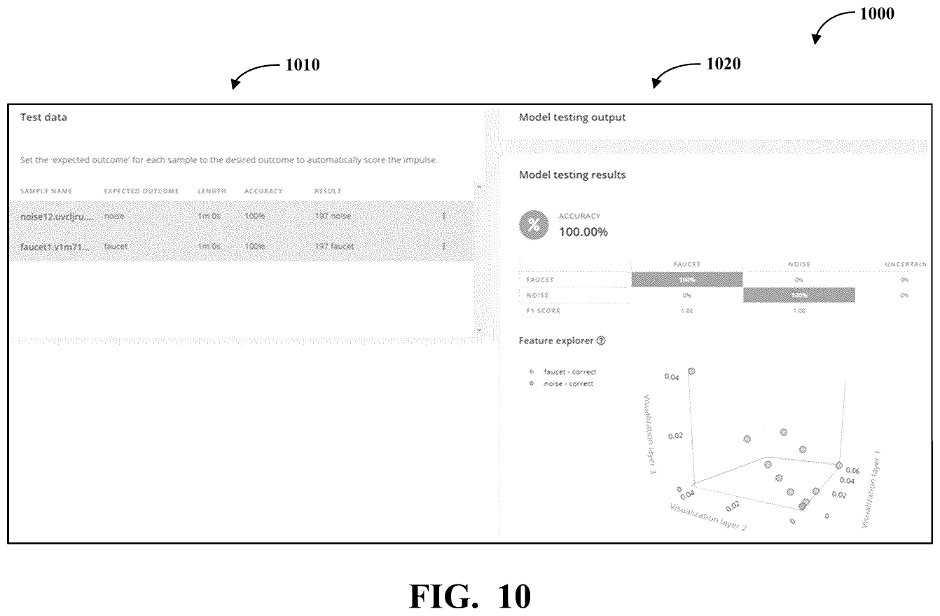

FIG. 10 is an illustration of an example of a GUI 1000 indicating testing of a configuration of a pipeline. The GUI 1000 could be output for display at a user interface like the user interface 212 shown in FIG. 2. For example, the GUI 1000 could be output for display to a user at a design control system like the design control system 320 shown in FIG. 3. The information associated with the GUI 800 may be accessible via an API.

The GUI 1000 may indicate test data 1010 used by the test service 316 for a configuration of the pipeline. For example, the test service 316 may use data from datasets stored in the database 324 to test the or more configurations of the pipeline. In one example, the test service 316 may test the one or more configurations of the pipeline with respect to a level of accuracy of predictions. The test service 316 may provide a testing output 1020 to a user, via the design control system 320, so that the user may accept or change a configuration of the pipeline based on the testing. The testing output 1020 may include, for example, a determined level of accuracy and a machine learning map. For example, the testing output 1020 may indicate the test service 316 has determined a level of accuracy of 100% for predictions based on the test data (e.g., classifying a data sample as “faucet,” indicating a sound of water running from a faucet, or “noise,” indicating a sound other than water running from a faucet.).

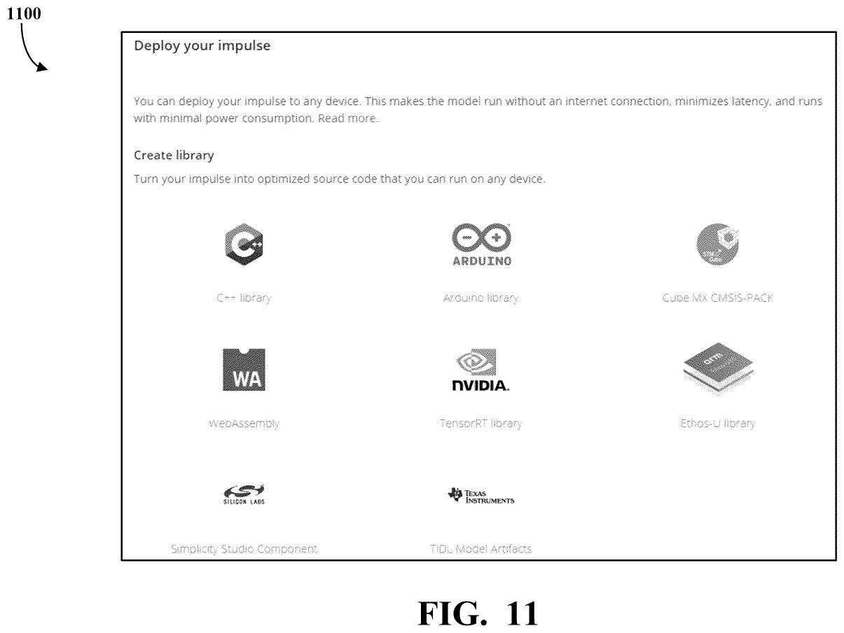

FIG. 11 is an illustration of an example of a GUI 1100 indicating deployment of a configuration of a pipeline to a library. A computer or other device (e.g., the target device 340) may use the library to implement a configuration of the pipeline. The GUI 1100 could be output for display at a user interface like the user interface 212 shown in FIG. 2. For example, the GUI 1100 could be output for display to a user at a design control system like the design control system 320 shown in FIG. 3. The information associated with the GUI 1100 may be accessible via an API.

The GUI 1100 may indicate multiple possible targets that are libraries. For example, possible libraries could include: a C++ library, Arduino library, Cube.MX CMSIS-PACK, WebAssembly, TensorRT library, Ethos-U library, and Simplicity Studio Component. A user may provide input (e.g., via the design control system 320) to select a library as a target. The deployment service 318 may receive the input and may utilize a software toolchain, specific to the library that is selected, for generating software for deploying a configuration of the pipeline to the library. For example, the deployment service 318 may include a compiler for generating compiled code targeting the library that is selected. A computer or other device (e.g., the target device 340) may use the library to implement a configuration of the pipeline.

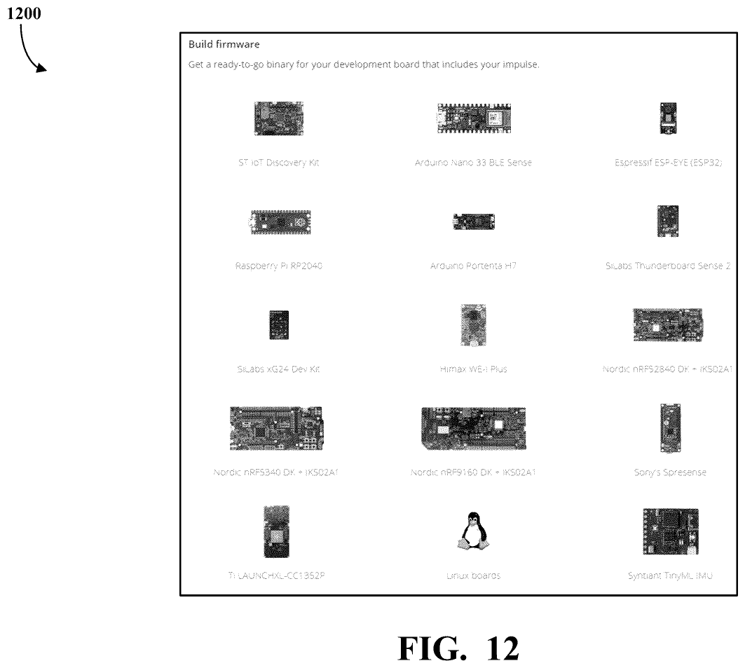

FIG. 12 is an illustration of an example of a GUI 1200 indicating deployment of a configuration of a pipeline to a device (e.g., the target device 340). The GUI 1200 could be output for display at a user interface like the user interface 212 shown in FIG. 2. For example, the GUI 1200 could be output for display to a user at a design control system like the design control system 320 shown in FIG. 3. The information associated with the GUI 1200 may be accessible via an API.

The GUI 1200 may indicate multiple possible target devices comprising microcontrollers or boards in a library. For example, possible target devices in the library could include: an ST IoT Discovery Kit, Arduino Nano 33 BLE Sense, Espressif ESP-EYE (SEP32), Raspberry Pi RP2040, Arduino Portenta H7, SiLabs Thunderboard Sense 2, SiLabs xG24 Dev Kit, Himax WE-I Plus, Nordic nRF52840 DK+IKS02A1, Nordic nRF5340 DK+IKS02A1. Nordic nRF9160 DK+IKS02A1, Nordic Thingy:53, Sony's Spresense, TI LAUNCHXL-CC1352P, and Linux Boards. A user may provide input (e.g., via the design control system 320) to select a microcontroller or board as a target device (e.g., the target device 340). The deployment service 318 may receive the input and may utilize a software toolchain, specific to the microcontroller or board that is selected, for generating software and/or firmware for deploying a configuration of the pipeline to the microcontroller or board. For example, the deployment service 318 may include a compiler for generating compiled code targeting the microcontroller or board that is selected, including software and/or firmware. In some implementations, the deployment service 318 may communicate with a programming system (e.g., the programming system 132) to send the software and/or firmware to a programming system for programming the microcontroller or board (e.g., programming a flash memory or ROM of the microcontroller).

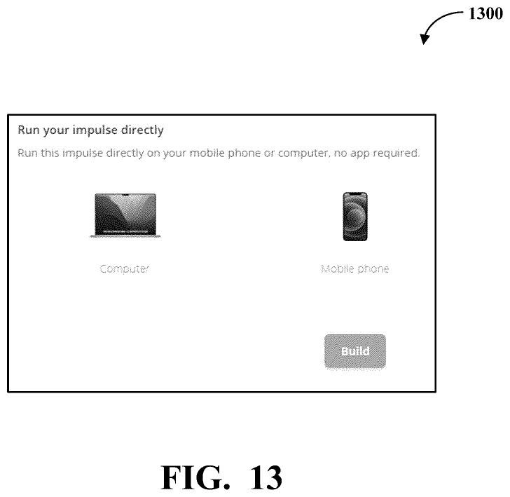

FIG. 13 is an illustration of an example of a GUI 1300 indicating deployment of a configuration of a pipeline to a computer or a mobile phone (e.g., the target device 340). The GUI 1300 could be output for display at a user interface like the user interface 212 shown in FIG. 2. For example, the GUI 1300 could be output for display to a user at a design control system like the design control system 320 shown in FIG. 3. The information associated with the GUI 1300 may be accessible via an API.

The GUI 1300 may indicate multiple possible target devices comprising computers or mobile phones in a library. A user may provide input (e.g., via the design control system 320) to select a computer or a mobile phone as a target device (e.g., the target device 340). The deployment service 318 may receive the input and may utilize a software toolchain, specific to the computer or the mobile phone that is selected, for generating software for deploying a configuration of the pipeline to the computer or the mobile phone. For example, the deployment service 318 may include a compiler for generating compiled code targeting the computer or the mobile phone that is selected. In some implementations, the deployment service 318 may communicate with the computer or the mobile phone (e.g., via the network 102) to send the software and/or firmware to the computer or the mobile phone, for the computer or the mobile phone to execute, for implementing the pipeline.

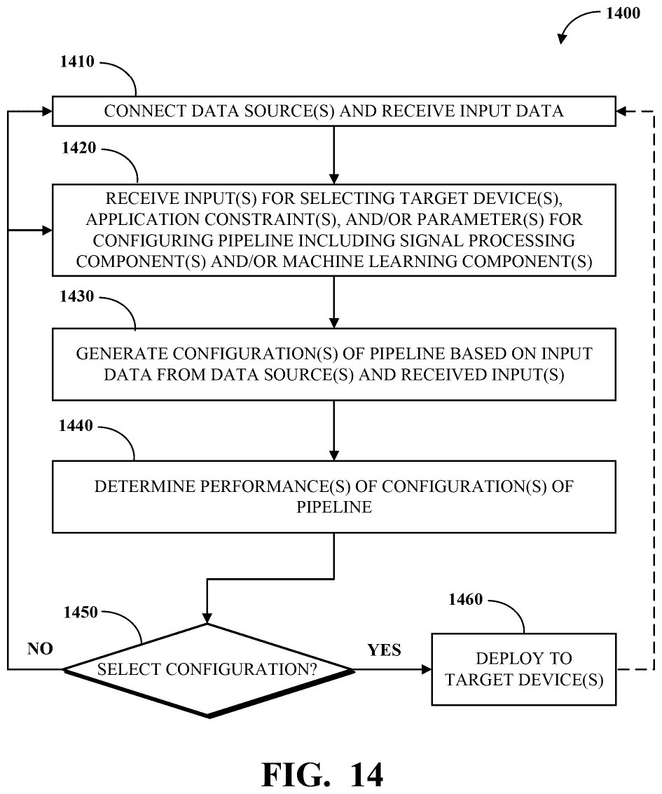

To further describe some implementations in greater detail, reference is next made to examples of techniques which may be performed when configuring a pipeline that includes a signal processing component and a machine learning component. FIG. 14 is a flow chart of an example of a technique 1400 for configuring a pipeline that includes a signal processing component and a machine learning component. The technique 1400 can be executed using computing devices, such as the systems, hardware, and software described with respect to FIGS. 1-13. The technique 1400 can be performed, for example, by executing a machine-readable program or other computer-executable instructions, such as routines, instructions, programs, or other code. The steps, or operations, of the technique 1400 or another technique, method, process, or algorithm described in connection with the implementations disclosed herein can be implemented directly in hardware, firmware, software executed by hardware, circuitry, or a combination thereof.

For simplicity of explanation, the technique 1400 is depicted and described herein as a series of steps or operations. However, the steps or operations in accordance with this disclosure can occur in various orders and/or concurrently. Additionally, other steps or operations not presented and described herein may be used. Furthermore, not all illustrated steps or operations may be required to implement a technique in accordance with the disclosed subject matter.

At 1410, a configuration service (e.g., the configuration service 310) may connect to one or more data sources (e.g., the one or more data sources 330). The configuration service may receive input data, from the one or more data sources, via a data ingestion service (e.g., data ingestion service 312). The data ingestion service that process the input data to generate one or more datasets that may be used to configure, train, and/or test a configuration of the pipeline. The input data may be processed according to a configuration, based on parameters, such as input axes for listing each axis referenced from the training dataset, window size defining the size of the raw features used for the training, window increase to extract multiple overlapping windows from a single sample, and frequency for sampling data. The one or more datasets may be stored by the configuration service in a database (e.g., the database 324). The one or more data sources could be selected and/or configured by a user via a design control system (e.g., the design control system 320). The one or more data sources could also be configured by the configuration service, such as for transferring the input data from the one or more data sources to the configuration service. The one or more data sources may include, for example, one or more servers, computers, mobile phones, or other electronic devices, such as microcontrollers or boards.

At 1420, the configuration service may receive one or more inputs, such as from a user via the design control system. The one or more inputs may include selection of a target device (e.g., the target device 340) from multiple possible target devices, including a microcontroller or board, a computer, or a mobile phone. The one or more inputs may also include an indication of one or more application constraints (e.g., a targeted latency, accuracy, memory usage, and/or energy usage). The one or more inputs may also include input data. The one or more inputs may also include an indication of one or more parameters, and/or a modification of one or more parameters determined by the configuration service, for configuring a pipeline that includes a signal processing component and a machine learning component. For example, the one or more parameters may be used to configure a signal processing component (e.g., settings that affect signal processing calculations, such as a particular DSP algorithm or noise floor) and/or a machine learning component (e.g., settings that affect machine learning, such as hyperparameters including neural network topology, size, or training) of the pipeline.

At 1430, the configuration service may generate multiple configurations of a pipeline based on the one or more inputs (e.g., the target device, the application constraints, the input data, and/or the one or more parameters). For example, a pipeline design service (e.g., the pipeline design service 314) of the configuration service may invoke a signal processing design service (e.g., the signal processing design service 326) and a machine learning design service (e.g., the machine learning design service 328) to generate the multiple configurations of the pipeline. For example, the configuration service may generate multiple configurations like the configurations 910A through 910C shown in FIG. 9.

At 1440, the configuration service may determine the performances of the multiple configurations of the pipeline. For example, the configuration service may determine the performances of the multiple configurations like the performances 810A through 810C shown in FIG. 8. In some implementations, the performance (e.g., the latency, the memory usage, the energy usage, or the accuracy) of a configuration may be determined by simulating the target device implementing the configuration (e.g., determining the performance based on characteristics of the target device, such as the architecture of a microcontroller or board, a computer, or a mobile phone. In some implementations, the performance of a configuration may be determined by referencing one or more benchmarks associated with the target device (e.g., predetermined performance data from a look up table or other data structure) and applying the one or more benchmarks to estimate the performance of the configuration when the target device implements the configuration. In some cases, a machine learning model or heuristic algorithm may be used to predict the performance of the configuration based on the one or more benchmarks. This may permit determining the performance more quickly when using benchmarks. In some implementations, the configurations may be ranked based on their performances. In some implementations, the performance of a configuration may be compared to an application constraint (e.g., a targeted latency, accuracy, memory usage, and/or energy usage) indicated by an input.

At 1450, the configuration service may determine whether a configuration of the multiple configurations is selected. A configuration may be selected, for example, by a user providing input via the design control system. In some implementations, a configuration may be automatically selected, such as when a configuration is determined to satisfy the application constraint. For example, a configuration may be automatically selected based on a rank of the configuration (e.g., a highest ranking accuracy and/or inference time, while satisfying the targeted memory usage and/or energy usage). If a configuration is not selected (“No”), the technique may repeat, such as by returning to 1410 (e.g., to connect another data source and/or receive additional input data) or 1420 (e.g., to receive additional inputs, or changes to inputs). If a configuration is selected (“Yes”), the technique may continue at 1460 in which the configuration may be deployed to the target device. In some implementations, the configuration may be implemented on a target device by utilizing a software toolchain for the target device, such as for generating firmware. In some implementations, implementing the configuration on a target device may include determining portions of the pipeline to be implemented on various cores of a heterogenous device, and distributing a computational workload associated with the pipeline across the various cores. In some implementations, the target device may be implemented in a field system (e.g., the field system 150), and in some cases, the target device may be used to provide input data to the configuration service as a data source, such as for testing the target device when it is implemented and/or implementing a next target device (e.g., a second target device).

As a result, a pipeline including one or more signal processing components and one or more machine learning components may be determined for an application and/or a device while reducing the time and/or the burden associated with making the determination. Further, the pipeline may be implemented on a target device while reducing the time and/or the burden associated with utilizing the software toolchain for the target device. Additionally, by determining configurations that include signal processing and machine learning components, trade-offs between signal processing efficiency (e.g., utilization of the signal processing component) and machine learning efficiency (e.g., utilization of the machine learning component) may be achieved.

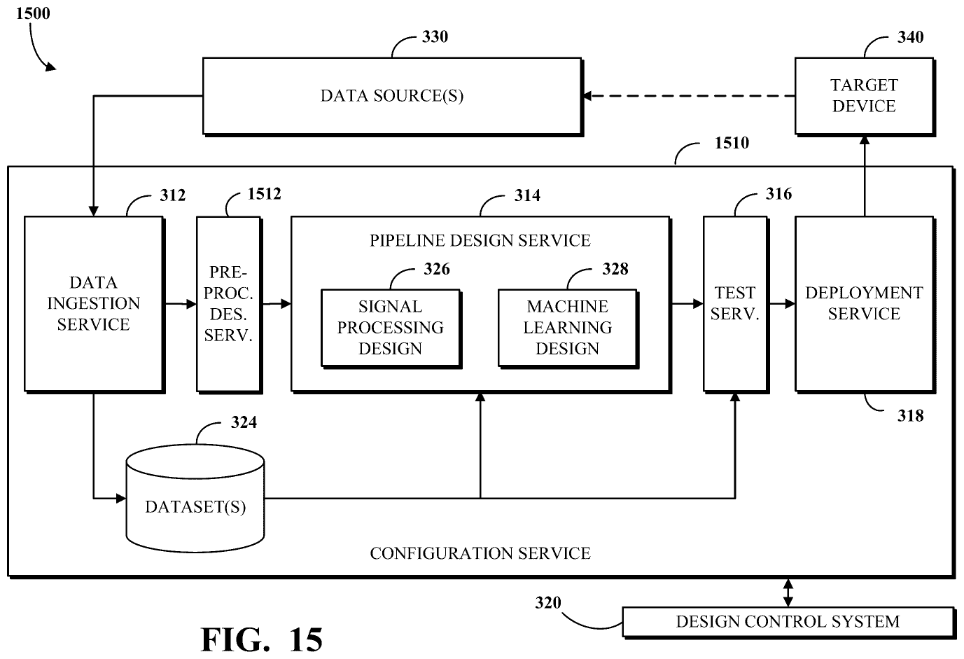

FIG. 15 is a block diagram of an example of a system 1500 for configuring a pipeline including a signal processing component and a machine learning component. The system 1500 may include a configuration service 1510, which may be like the configuration service 310 shown in FIG. 3. For example, the configuration service 310 may include the data ingestion service 312, the pipeline design service 314 (including the signal processing design service 326 and the machine learning design service 328), the test service 316, the deployment service 318, and the database 324. The configuration service 1510 may further include a pre-processing design service 1512 (e.g., a DSP configuration service). The system 1500 may also include the design control system 320, the one or more data sources 330, and the target device 340, as described in FIG. 3.

The pre-processing design service 1512 may be arranged between the data ingestion service 312 and the pipeline design service 314. The pre-processing design service 1512 may be used to configure a signal processing component (e.g., a DSP component) for the signal processing design service 326, before the machine learning design service 328 trains a machine learning model to be implemented by a machine learning component. The pre-processing design service 1512 may determine values of one or more parameters for the DSP component (e.g., parameters which may be used by a DSP function implemented by the DSP component). The pre-processing design service 1512 may also determine DSP functions which may be used by the DSP component. The pre-processing design service 1512 may determine the values and/or the DSP functions based on input data (e.g., samples of input data, which could be received from the data ingestion service 312).

The configuration service 1510 can generate a configuration of a pipeline, including a DSP component generated by the signal processing design service 326 (with input from the pre-processing design service 1512), and a machine learning component generated by the machine learning design service 328. The pipeline may be implemented on the target device 340, which could be a specified microcontroller, board, computer, or mobile phone. The signal processing design service 326 can generate the DSP component rapidly based on input from the pre-processing design service 1512, without the machine learning design service 328 training a model for the machine learning component. As a result, the configuration service 1510 can generate the configuration of the pipeline more efficiently.

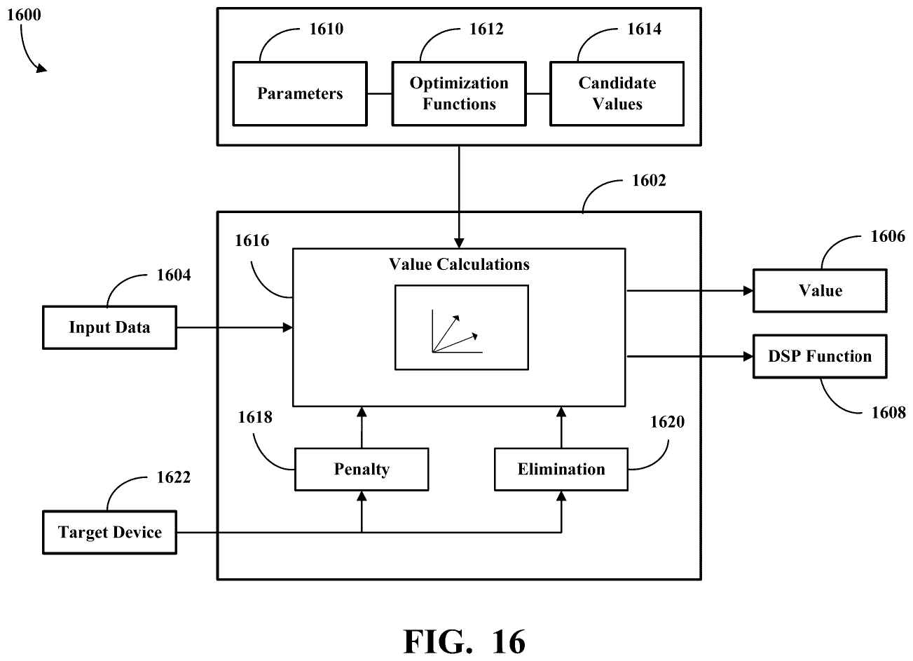

FIG. 16 is a block diagram of an example of a system 1600 for determining a value 1606 of a parameter for a DSP component based on input data 1604 corresponding to classes. The system 1600 could be implemented by the pre-processing design service 1512 shown in FIG. 15. The system 1600 may include a selection system 1602. The selection system 1602 may select a DSP function 1608 and the value 1606 for a parameter which may be applied by a DSP component implementing the DSP function (e.g., the DSP component generated by the signal processing design service 326). The input data 1604 may be specific to a given application. The selection system 1602 may select the value 1606 based on mathematical properties of the input data 1604 associated with the application. The dataset may include samples of labeled data corresponding to classes (e.g., classes which the machine learning model may be trained to predict). In some implementations, the input data 1604 could be time series data, such as audio data from a microphone, or data from the multiple axes of an accelerometer. For example, the input data 1604 could be samples of audio data corresponding to different labeled classes, such as “yes” or “no” (e.g., one or more samples could be labeled “yes,” corresponding to captured audio data in which the word “yes” is spoken, and one or more samples could be labeled “no,” corresponding to captured audio data in which the word “no” is spoken).

The selection system 1602 may determine the value 1606 of the parameter for the DSP component, for the given application, based on the input data 1604. The selection system 1602 may also determine the DSP function 1608 for the DSP component, for the given application, based on the input data 1604. The DSP component may be used to control digital signal processing of input data, such as the input data 1604, to generate features for a machine learning model to identify the classes. For example, the DSP component could be generated by the machine learning design service 328 based on the value 1606 and/or the DSP function 1608. The DSP component may control digital signal processing of input data so that a machine learning model implemented by a machine learning component can identify classes from features generated by the DSP component (e.g., the classes “yes” and “no”). The features may be characteristics in the data which may result from the digital signal processing. In some implementations, the selection system 1602 may use a greedy algorithm to select the value 1606 and/or the DSP function 1608 based on the input data 1604 associated with the application. The selection system 1602 may advantageously select the value 1606 and/or the DSP function 1608 before the machine learning design service 328 trains the machine learning model. This may enable determining values of parameters and/or DSP functions for a DSP component without the involvement of a skilled engineer and in less time than a trial and error design approach.

The selection system 1602 may access a data store including a set of parameters 1610, a set of optimization functions 1612, and sets of candidate values 1614 (candidate values for parameters in the set of parameters 1610). The parameters may be tunable parameters that apply to one more DSP functions, such as an MFE function, an MFCC function, a spectrogram function, and/or a spectral analysis function. For example, parameters that may apply to the MFE function may include frame length (the length of a frame in seconds), frame stride (the step between successive frames in seconds), filter number (the number of filters in the filterbank), FFT length (the number of frequency bands or FFT points, which may be selected in powers of 2), low frequency (a lowest band edge of mel filters, in Hz), high frequency (a highest band edge of mel filters, in Hz), and noise floor (dropping everything less than the noise floor (in dB)). Parameters that may apply to the spectrogram function may include frame length, frame stride, FFT length, and noise floor. Parameters that may apply to the MFCC function may include number of coefficients (number of cepstral coefficients), frame length, frame stride, filter number, FFT length, normalization window size (the size of a sliding window for local normalization, which could be set to 0 to disable normalization), low frequency, high frequency, pre-emphasis filter coefficient (the pre-emphasizing coefficient to apply to the input signal, which can be disabled), and pre-emphasis filter shift (the pre-emphasis shift to roll over the input signal). Parameters that may apply to the spectral analysis function may include filter cutoff frequency (e.g., 2 Hz), filter type (e.g., high-pass, low-pass, or band-pass) and algorithm type (e.g., FFT, which may result in one set of additional parameters, such as FFT length, overlap frames (yes/no), and generating log of powers (yes/no); and wavelet decomposition, which may result in another set of additional parameters, such as wavelet family, and decomposition level). In some cases, a parameter in the set of parameters 1610 may be usable by a single DSP function. For example, filter cutoff might be used by only the spectral analysis function. In some cases, a parameter in the set of parameters 1610 may be usable by multiple DSP functions. For example, FFT length, frame length, and frame stride might be used by each of the MFE function, the MFCC function, and the spectrogram function.

Each parameter in the set of parameters 1610 may be associated with a different optimization function in the set of optimization functions 1612. A parameter may be associated with an optimization function, for example, based on one or more mathematical properties of the parameter. To generate the value 1606 for a parameter, and/or the DSP function 1608, the selection system 1602 may select an optimization function from the set of optimization functions 1612 that is associated with the parameter. Once the optimization function is selected, a processing block 1616 of the selection system 1602 may calculate the optimization function using the input data 1604 and a set of candidate values for the parameter from the sets of candidate values 1614. In some implementations, the processing block 1616 may determine a particular candidate value that maximizes the optimization function, and may output that particular candidate value as the value 1606 (e.g., a recommended value, which may be transmitted to the signal processing design service 326). For example, the processing block 1616 may apply the formula Pₒ=max (F (P₁), . . . F (Pₙ)), where P₁ . . . n represents a set of n different candidate values for the parameter to be optimized (from the sets of candidate values 1614), where F represents the particular optimization function associated with the parameter to be optimized (from the set of optimization functions 1612), and where Pₒ is the particular candidate value that maximizes the optimization function (output as the value 1606).

In some implementations, an optimization function might measure a distance between vectors calculated by a DSP function across a subset of the input data 1604 (e.g., raw data samples). For example, a machine learning classifier (e.g., a model generated by the machine learning design service 328) may perform better when the classes are mutually distant from one another in a feature space. The optimization function may result in the value 1606 that maximize this distance, so that better performance may be achieved for the classifier. In various implementations, the optimization function can use a variety of distance measurement formulas. In one example, Pₒ (the particular candidate value that maximizes the optimization function) may be calculated by the processing block 1616 by following steps: (1) select a candidate value (Pₙ) (e.g., from the sets of candidate values 1614); (2) calculate output features, X₁ . . . m, for a subset of raw input data vectors, x₁ . . . m, across all classes (e.g., from the input data 1604); (3) for each class, sum the output features, S₁ . . . c=ΣX₁ . . . p, where p is the number of samples from a given class c, for classes 1 to c; (4) calculate the mean of the distance function, D, between each unique pair of vectors S calculated above, that is, mean (D (S₁, S₂) . . . D (Sc−1, Sc)) (the optimization function F_{distance}); and (5) repeat the above procedure for all candidate values Pn in the set candidate values P. The candidate value Pn that maximizes the optimization function F_{distance} may be output as the value 1606.

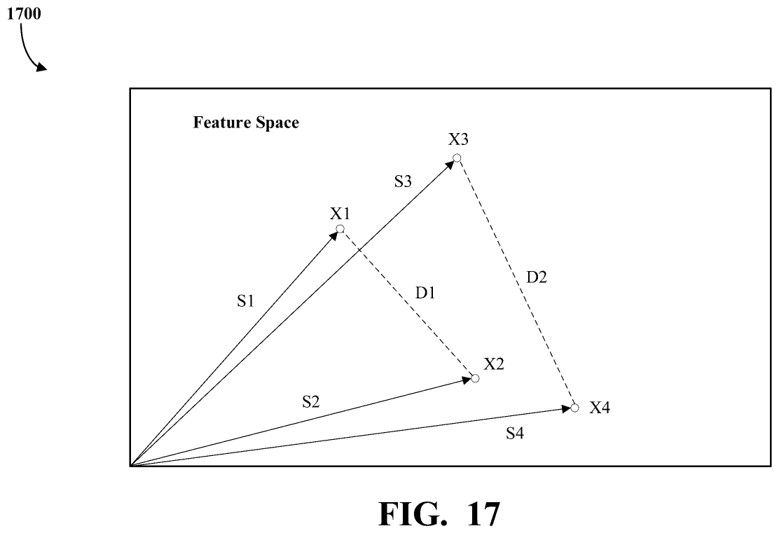

For example, with additional reference to FIG. 17, in a simplified case illustrating a feature space 1700, the processing block 1616 may select a first candidate value P₁ from a set of candidate values (of the sets of candidate values 1614). The processing block 1616 may use the first candidate value to calculate output features from the input data 1604. This could result in a first output feature X1 corresponding to a first class c1 (e.g., the class labeled “yes,” associated with a first sample) and a second output feature X2 corresponding to a second class c2 (e.g., the class labeled “no,” associated with a second sample). A first vector S1 to the first output feature X1, and second vector S2 to the second output feature X2, may be used to calculate the first distance D1, indicating a first separation of the classes (e.g., using the first candidate value). Repeating for the next candidate value, the processing block 1616 may select a second candidate value P₂ from the set of candidate values. The processing block 1616 may use the second candidate value to calculate output features from the input data 1604. This could result in a third output feature X3 corresponding to the first class c1 (e.g., the class labeled “yes,” associated with the first sample) and a fourth output feature X4 corresponding to the second class c2 (e.g., the class labeled “no,” associated with the second sample). A third vector S3 to the third output feature X3, and fourth vector S4 to the fourth output feature X4, may be used to calculate the second distance D2, indicating a second separation of the classes (e.g., using the second value). The processing block 1616 may determine the second distance D2 is greater than the first distance D1, and therefore the second candidate value maximizes the optimization function. The processing block 1616 may therefore return the second candidate, which the selection system 1602 may output as the value 1606. In the feature space shown by this example, four dots are present (X1, X2, X3, and X4) based on two samples of data used, corresponding to the first class c1 and the second class c2 (e.g., the input data 1604), and two candidate values.

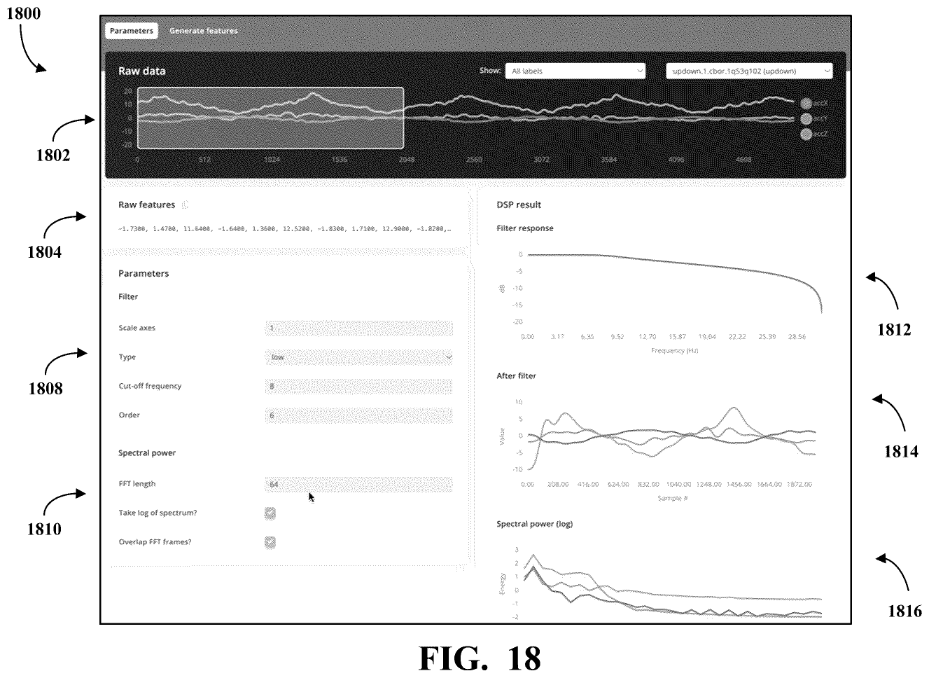

With additional reference to FIG. 18, an illustration of an example of a GUI 1800 may indicate an interactive view for determining a value of a parameter based on input data corresponding to classes. The GUI 1800 could be output for display at a user interface like the user interface 212 shown in FIG. 2. For example, the GUI 1800 could be output for display to a user at a design control system like the design control system 320 shown in FIG. 15. In some cases, invoking the pre-processing design service 1512 shown in FIG. 15 may cause display of the GUI 1800. The information associated with the GUI 1800 may be accessible via an API.

To assist in the pre-processing configuration, the GUI 1800 may enable a user to review input data (e.g., the input data 1604, which could be raw data, or data processed by the data ingestion service 312). In this example, the input data may correspond to samples of data from a 3-axis accelerometer. The samples of data could be in four classes (e.g., “idle,” “snake,” “updown,” or “wave,” which may correspond to different movements of a device including the accelerometer, with each sample being labeled in one of the classes). A waveform 1802 for one particular sample corresponding to one particular class could be selected and examined in a top portion of the GUI 1800. Selection of the waveform 1802 may also indicate raw features 1804 corresponding to the waveform 1802 (which may affect digital signal processing). The GUI 1800 may also indicate values 1808 of parameters applied by a selected DSP function, which could be modified by the user in the GUI 1800. The GUI 1800 may also indicate spectral power 1810 associated with the values 1808 of parameters applied by applied by the DSP function. The GUI 1800 may also indicate a first graph 1812 that is representative of a response of the DSP component, corresponding to the values 1808 of parameters applied by applied by the DSP function. The GUI 1800 may also indicate a second graph 1814 that is generated after applying the DSP function to the sample. The GUI 1800 may also indicate a third graph 1816 that is representative of the spectral power 1810 associated with the sample after applying the DSP function (e.g., energies at multiple frequencies).

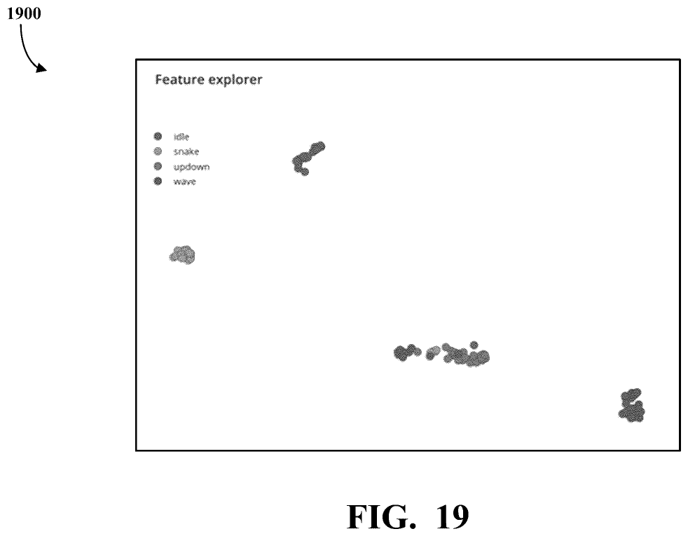

With additional reference to FIG. 19, an illustration of an example of a GUI 1900 may indicate a feature space including results generated by a DSP function applying a candidate value (e.g., a selected candidate value, which may be the value 1606, applied by a DSP function, such as the DSP function 1608). The GUI 1900 may demonstrate a feature space like the feature space 1700 shown in FIG. 17. The GUI 1900 could be output for display at a user interface like the user interface 212 shown in FIG. 2. For example, the GUI 1900 could be output for display to a user at a design control system like the design control system 320 shown in FIG. 15.

The GUI 1900 could be output based on a selection in the GUI 1800 to generate features. The example shown in the GUI 1900 includes the four classes (e.g., labels corresponding to “idle.” “snake.” “updown,” and “wave”) described with respect to FIG. 18. In the feature space shown by this example, multiple dots are present based on multiple samples of data being used (e.g., a first set of samples corresponding to “idle,” a second set of samples corresponding to “snake,” a third set of samples corresponding to “updown,” and a fourth set of samples corresponding to “wave”) with a selected candidate value.

Returning to FIG. 16, by way of example, the selection system 1602 could generate a value 1606 for a parameter corresponding to FFT size (Pₒ). The selection system 1602 may select an optimization function from the set of optimization functions 1612 that is associated with FFT size. The selection system 1602 may also determine a set of candidate values (from the sets of candidate values 1614) corresponding to FFT size (a set P), such as FFT size={16, 32, 64, 128, 256, 512, 1024, 2048, 4096}. The processing block 1616 can then generate class vectors S₁ . . . c as described above with one vector for each class. For the distance function in this case, the processing block 1616 could apply 1−cosine similarity, such as 1−((A·B)/(∥A∥ ∥B∥)). This may enable the selection system 1602 to output the value 1606 for the FFT size.

In some implementations, the selection system 1602 could determine the DSP function 1608 based on comparing one result associated with one DSP function to another result associated with another DSP function. For example, the processing block 1616 could extend P with selections other than FFT size. The processing block 1616 could calculate wavelet transforms, and calculate various wavelet types and families. When doing so, the processing block 1616 is not only determining an FFT size for the value 1606, but also determining first, whether to use FFT or Wavelet transform, and then, additionally determining the configuration of that algorithm, which could be FFT size in the case of FFT based processing, or Wavelet family and type for Wavelet based processing. The processing block 1616 may then return the value 1606 and the DSP function 1608 based on comparing the results. For example, the processing block 1616 may return the value 1606 as a selected FFT size, such as 64, as well as the DSP function 1608 as MFE, MFCC, or spectrogram, using FFT (as opposed to selecting a wavelet transform).

In some implementations, the selection system 1602 may apply a penalty factor 1618 to the optimization function calculated by the processing block 1616. The penalty factor 1618 may weigh against candidate values associated with a greater consumption of resources of a target device (e.g., the target device 340). For example, for deployment on an embedded system, the selection system 1602 may be biased to select values (e.g., the value 1606) that are not strictly optimal according to the optimization functions, so as to favor values that consume less resources (e.g., RAM, ROM, processing cycles, and power) on the deployed target device. To promote these smaller sizes, the penalty factor 1618 could provide a configurable factor, Z, to penalize larger sizes. For example, this may change the optimization function from F(p) to Z^{p}F(p), where Z is the penalty factor in the range 0<Z<1, and where p is a tested value (e.g., 1024, in the case of FFT size, so that the optimization function is weighted against the larger FFT size, in favor of selecting a smaller FFT size, such as 64). This may enable implementation of a more efficient design in the system that optimizes values of a parameters while consuming fewer resources associated with the target device.

In some implementations, the selection system 1602 may receive an input indicating a target device 1622. For example, the input indicating the target device 1622 could be specified by user input, such as by a user using the design control system 320 shown in FIG. 15. The input indicating the target device 1622 could be used by the selection system 1602 to determine the resources available in the target device. For example, the selection system 1602 may determine one set of available resources (e.g., total RAM, total ROM, processing speed, and available power) based on the input indicating one type of target device (e.g., a first microcontroller), or another set of resources (e.g., total RAM, total ROM, processing speed, and available power) based on the input indicating another type of target device (e.g., a second microcontroller). In some implementations, the selection system 1602 could configure the penalty factor 1618 based on the input indicating the target device 1622. For example, the selection system 1602 could decrease penalties when a target device has greater resources, and increase penalties when a target device has fewer resources.

In some implementations, the selection system 1602 may eliminate one or more candidate values from a set of candidate values based on the input indicating the target device 1622. This may correspond to limiting the set P based on knowledge of the user's intended hardware target. In this case, the selection system 1602 could apply an elimination block 1620 to eliminate candidate values from a set of candidate values (from the sets of candidate values 1614) calculated by the processing block 1616. The elimination 1620 may enable eliminating candidate values (e.g., pruning) above one threshold based on resources of a target device being below another threshold. For example, the elimination 1620 may eliminate any FFT size above 512 (so that such sizes could not be output as the value 1606) for a target device with less than 100K of RAM available.

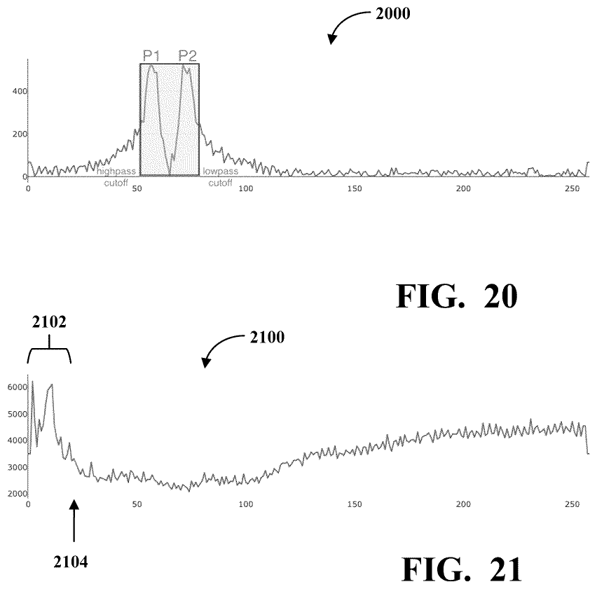

In some implementations, the processing block 1616 may apply an optimization function that compares spectral energies at multiple frequencies (calculated using a DSP function, based on the input data 1604). For example, the spectral analysis function may enable one or more filters to be applied, such as a low-pass filter, a high-pass filter, or a band-pass filter, specified by a parameter. Each filter may have an associated cutoff frequency specified by another parameter. The selection system 1602 may select a filter type (e.g., low-pass, high-pass, or band-pass) and cutoff frequency (e.g., the value 1606) when selecting the spectral analysis function (e.g., the DSP function 1608). The selection system 1602 may determine such selections based on analysis of the input data 1604 by the processing block 1616. For example, with additional reference to FIG. 20, in a graph 2000 of input data showing differences of spectral energies at multiple frequencies, the processing block 1616 may determine a filter type and a cutoff frequency that retains prominent components in a spectral difference, given by F=mean (D (S₁, S₂) . . . D (S_{c}−1, S_{c})). The processing block 1616 may detect prominent peaks based on a spectral difference function (e.g., peaks P₁ and P₂ in the graph 2000), by applying F(k)>T_{f}; k=0 . . . K−1, and F(k)>max (F (k−n . . . k+n)); n=−N . . . N, n≠0, where K is the size of the spectrum, T_{f} and N is an empirically determined peak threshold and peak margin. From a set of peaks P₁ . . . Pₘ, where m is the number of peaks, ordered from lowest to highest frequency, the processing block 1616 can select the first and last peak to guide a selection of cutoff frequencies. Specifically, the high-pass cutoff may be set to where the amplitude of F decreases to 50% of P₁ on the lower frequency side. Similarly, the low-pass cutoff may be set to where the amplitude of F decreases to 50% of the Pₘ on the higher frequency side.

As a result, the cutoff frequencies may be selected so that the most prominent spectral differences are retained. In some implementations, this approach may select a low-pass filter if a high-pass cutoff is close to 0; a high-pass filter if a low-pass cutoff is close to the Nyquist frequency; and a band-pass filter if both the high-pass cutoff and low-pass cutoff are in valid ranges. For example, with additional reference to FIG. 21, in a graph 2100 of input data showing differences of spectral energies at multiple frequencies, the processing block 1616 may determine that the most differentiable components are located at low frequencies (e.g., in the region 2102). As a result, the processing block 1616 may apply a low-pass filter that retains those components. For example, an output of the filter tuning provided by the selection system 1602 could be [‘low’, ‘2.8 hz’] (e.g., low-pass filter, where 2.8 Hz is at about point 2104 in the plot).

In some implementations, the processing block 1616 may determine that the filter affects the FFT size. In such cases, the processing block 1616 may output a minimum FFT size, which may be operable to ensure that a subsequent FFT analysis provides a minimum resolution for a filtered signal. For example, the processing block 1616 may determine that a minimum FFT size of 32 is to accompany the recommended low pass filter for the spectral differences shown in FIG. 21.

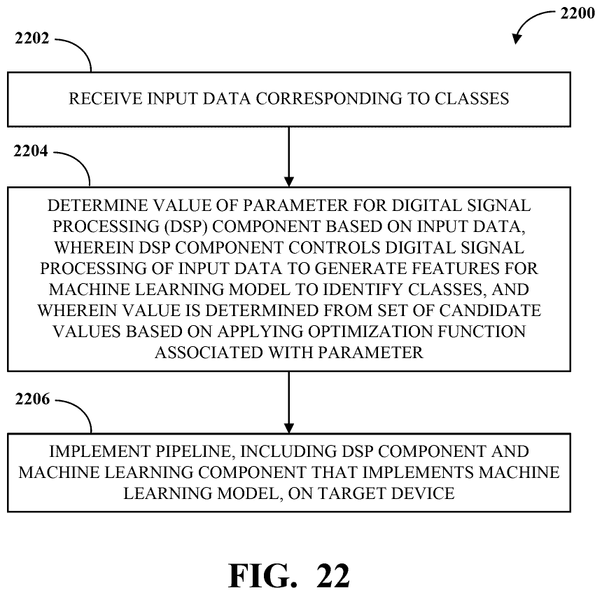

FIG. 22 is a flow chart of an example of a technique 2200 for determining a value of a parameter for a DSP component based on input data corresponding to classes. The technique 2200 can be executed using computing devices, such as the systems, hardware, and software described with respect to FIGS. 1-21. The technique 2200 can be performed, for example, by executing a machine-readable program or other computer-executable instructions, such as routines, instructions, programs, or other code. The steps, or operations, of the technique 2200 or another technique, method, process, or algorithm described in connection with the implementations disclosed herein can be implemented directly in hardware, firmware, software executed by hardware, circuitry, or a combination thereof.

For simplicity of explanation, the technique 2200 is depicted and described herein as a series of steps or operations. However, the steps or operations in accordance with this disclosure can occur in various orders and/or concurrently. Additionally, other steps or operations not presented and described herein may be used. Furthermore, not all illustrated steps or operations may be required to implement a technique in accordance with the disclosed subject matter.

At 2202, a configuration service may receive input data corresponding to classes (e.g., samples corresponding to labeled classes). For example, the configuration service 1510, using the data ingestion service 312, may receive input data corresponding to classes, such as the input data 1604. The input data could be time series data, such as audio data from a microphone or data from the multiple axes of an accelerometer. In some implementations, the input data could be sensor data. A sample of the input data may be labeled to correspond to a particular class (e.g., a class which a machine learning model may later predict, such as “yes” or “no,” or various movements detected by a 3-axis accelerometer).

At 2204, a selection system (e.g., the selection system 1602), implemented by a pre-processing design service (e.g., the pre-processing design service 1512) of the configuration service, may determine a value (e.g., the value 1606) of a parameter for a DSP component. The selection system may determine the value based on the input data. The selection system may determine the value before training the machine learning model to identify the classes based on the features. The selection system may also determine a DSP function (e.g., the DSP function 1608) based on the input data. The selection system may determine the DSP function before training the machine learning model to identify the classes based on the features. The DSP component may implement the DSP function applying the parameter. The DSP component may control digital signal processing of the input data to generate features (e.g., a features space) for the machine learning model to identify the classes (e.g., a machine learning model generated by the machine learning design service 328). A processing block (e.g., the processing block 1616) of the selection system may determine the value from a set of candidate values (e.g., from the sets of candidate values 1614) based on applying an optimization function associated with the parameter (e.g., from a parameter in the set of parameters 1610). The selection system may determine the optimization function (e.g., from the set of optimization functions 1612) associated with the parameter.

In some implementations, the value may be determined to be the candidate value that maximizes the optimization function. In some implementations, the optimization function may measure a distance between vectors calculated by a DSP function implemented. In some implementations, the optimization function may compare spectral energies at multiple frequencies as calculated by a DSP function. In some implementations, the DSP function may be determined by comparing a first result associated with a first DSP function to a second result associated with a second DSP function. In some implementations, the selection system may apply a penalty factor to the optimization function. The penalty factor may weigh against candidate values associated with a greater consumption of resources of a target device. In some implementations, the selection system may eliminate candidate values based on input indicating the target device.

At 2206, the configuration service may implement a pipeline, including the DSP component and a machine learning component that implements the machine learning model, on the target device. A signal processing design service (e.g., the signal processing design service 326) may generate the DSP component based on the value and/or the DSP function determined by the selection system. A machine learning design service (e.g., the machine learning design service 328) may generate the machine learning component. The configuration service may implement the pipeline, including the DSP component and the machine learning component, on a target device (e.g., the target device 340, such as a microcontroller).

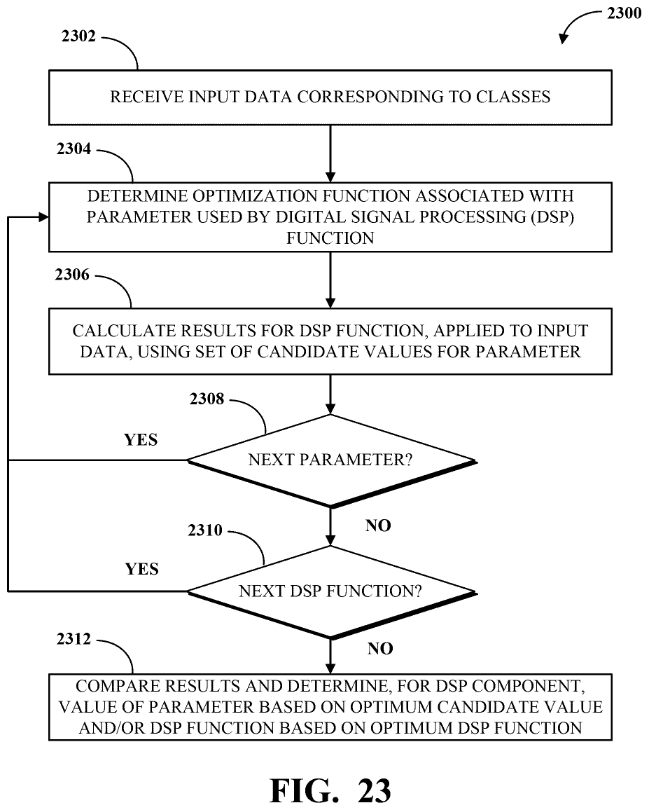

FIG. 23 is a flow chart of an example of a technique 2300 for determining a value of a parameter and/or a DSP function. The technique 2300 can be executed using computing devices, such as the systems, hardware, and software described with respect to FIGS. 1-21. The technique 2300 can be performed, for example, by executing a machine-readable program or other computer-executable instructions, such as routines, instructions, programs, or other code. The steps, or operations, of the technique 2300 or another technique, method, process, or algorithm described in connection with the implementations disclosed herein can be implemented directly in hardware, firmware, software executed by hardware, circuitry, or a combination thereof.

For simplicity of explanation, the technique 2300 is depicted and described herein as a series of steps or operations. However, the steps or operations in accordance with this disclosure can occur in various orders and/or concurrently. Additionally, other steps or operations not presented and described herein may be used. Furthermore, not all illustrated steps or operations may be required to implement a technique in accordance with the disclosed subject

At 2302, a configuration service may receive input data corresponding to classes (e.g., samples corresponding to labeled classes). For example, the configuration service 1510, using the data ingestion service 312, may receive input data corresponding to classes, such as the input data 1604. The input data could be time series data, such as audio data from a microphone or data from the multiple axes of an accelerometer. In some implementations, the input data could be sensor data. A sample of the input data may be labeled to correspond to a particular class (e.g., a class which a machine learning model may later predict, such as “yes” or “no,” or various movements detected by a 3-axis accelerometer).

At 2304, a selection system (e.g., the selection system 1602), implemented by a pre-processing design service (e.g., the pre-processing design service 1512) of the configuration service, may determine an optimization function (e.g., from the set of optimization functions 1612) associated with a parameter (e.g., from a parameter in the set of parameters 1610).

At 2306, a processing block (e.g., the processing block 1616) of the selection system may calculate results for a DSP function, applied to the input data, using a set of candidate values for the parameter (e.g., one candidate value at a time). At 2308, the processing block may then determine whether a next parameter is to be calculated. If a next parameter is to be calculated (“Yes”), the processing block may return to 2304 to determine an optimization function for the next parameter, and to 2306 to calculate results for a DSP function, applied to the input data, using a set of candidate values for the next parameter. If a next parameter is not to be calculated (“No”), at 2310, the processing block may determine whether a next DSP function is to be calculated for a parameter. If a next DSP function is to be calculated (“Yes”), the processing block may return to 2304 to determine an optimization function for a parameter, and to 2306 to calculate results for the next DSP function, applied to the input data, using a set of candidate values for the parameter. If a next DSP function is not to be calculated (“No”), at 2312, the processing block may compare results from the calculations. Based on comparing the results, the processing block may determine, for a DSP component, values of one or more parameters based on optimum candidate values and/or one or more DSP functions based on optimum DSP functions. The selection system may output the determined values and and/or DSP functions for implementation, such as to a signal processing design service (e.g., the signal processing design service 326) or a GUI (e.g., the GUI 1800).

The implementations of this disclosure can be described in terms of functional block components and various processing operations. Such functional block components can be realized by a number of hardware or software components that perform the specified functions. For example, the disclosed implementations can employ various integrated circuit components (e.g., memory elements, processing elements, logic elements, look-up tables, and the like), which can carry out a variety of functions under the control of one or more microprocessors or other control devices. Similarly, where the elements of the disclosed implementations are implemented using software programming or software elements, the systems and techniques can be implemented with a programming or scripting language, such as C, C++, Java, JavaScript, assembler, or the like, with the various algorithms being implemented with a combination of data structures, objects, processes, routines, or other programming elements.

Functional aspects can be implemented in algorithms that execute on one or more processors. Furthermore, the implementations of the systems and techniques disclosed herein could employ a number of conventional techniques for electronics configuration, signal processing or control, data processing, and the like. The words “mechanism” and “component” are used broadly and are not limited to mechanical or physical implementations, but can include software routines in conjunction with processors, etc. Likewise, the terms “system” or “tool” as used herein and in the figures, but in any event based on their context, may be understood as corresponding to a functional unit implemented using software, hardware (e.g., an integrated circuit, such as an application specific integrated circuit (ASIC)), or a combination of software and hardware. In certain contexts, such systems or mechanisms may be understood to be a processor-implemented software system or processor-implemented software mechanism that is part of or callable by an executable program, which may itself be wholly or partly composed of such linked systems or mechanisms.

Implementations or portions of implementations of the above disclosure can take the form of a computer program product accessible from, for example, a computer-usable or computer-readable medium. A computer-usable or computer-readable medium can be a device that can, for example, tangibly contain, store, communicate, or transport a program or data structure for use by or in connection with a processor. The medium can be, for example, an electronic, magnetic, optical, electromagnetic, or semiconductor device.

Other suitable mediums are also available. Such computer-usable or computer-readable media can be referred to as non-transitory memory or media, and can include volatile memory or non-volatile memory that can change over time. The quality of memory or media being non-transitory refers to such memory or media storing data for some period of time or otherwise based on device power or a device power cycle. A memory of an apparatus described herein, unless otherwise specified, does not have to be physically contained by the apparatus, but is one that can be accessed remotely by the apparatus, and does not have to be contiguous with other memory that might be physically contained by the apparatus.

While the disclosure has been described in connection with certain implementations, it is to be understood that the disclosure is not to be limited to the disclosed implementations but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A method, comprising:
receiving input data corresponding to classes; and
determining a value of a parameter for a digital signal processing (DSP) component based on the input data, wherein the DSP component controls digital signal processing of the input data to generate features for a machine learning model to identify the classes, and wherein the value is determined from a set of candidate values based on applying an optimization function associated with the parameter.

2. The method of claim 1, wherein the value corresponds to a candidate value of the set of candidate values that maximizes the optimization function.

3. The method of claim 1, wherein the optimization function measures a distance between vectors calculated by a DSP function implemented by the DSP component.

4. The method of claim 1, wherein the optimization function compares spectral energies at multiple frequencies as calculated by a DSP function implemented by the DSP component.

5. The method of claim 1, further comprising:
determining a DSP function implemented by the DSP component based on comparing a first result associated with a first DSP function to a second result associated with a second DSP function.

6. The method of claim 1, wherein the value is determined before training the machine learning model to identify the classes based on the features.

7. The method of claim 1, further comprising:
applying a penalty factor to the optimization function, wherein the penalty factor weighs against a candidate value of the set of candidate values associated with a greater consumption of resources of a target device.

8. The method of claim 1, further comprising:
receiving an input indicating a target device; and
eliminating a candidate value of the set of candidate values based on the input indicating the target device.

9. The method of claim 1, further comprising:
implementing a pipeline, including the DSP component and a machine learning component that implements the machine learning model, on a target device.

10. An apparatus, comprising:
a memory; and
a processor configured to execute instructions stored in the memory to:
receive input data corresponding to classes; and
determine a value of a parameter for a DSP component based on the input data, wherein the DSP component controls digital signal processing of the input data to generate features for a machine learning model to identify the classes, and wherein the value is determined from a set of candidate values based on applying an optimization function associated with the parameter.

11. The apparatus of claim 10, wherein the value is a candidate value that maximizes the optimization function.

12. The apparatus of claim 10, wherein the optimization function measures a distance between vectors calculated by a DSP function implemented by the DSP component.

13. The apparatus of claim 10, wherein the optimization function compares spectral energies at multiple frequencies as calculated by a DSP function implemented by the DSP component.

14. The apparatus of claim 10, wherein the processor is further configured to execute instructions stored in the memory to:
apply a penalty factor to the optimization function, wherein the penalty factor penalizes a candidate value of the set of candidate values associated with a greater consumption of resources of a target device.

15. The apparatus of claim 10, wherein the processor is further configured to execute instructions stored in the memory to:
receive an input indicating an embedded device; and
eliminate a candidate value of the set of candidate values based on the input indicating the embedded device.

16. A non-transitory computer readable medium storing instructions operable to cause one or more processors to perform operations comprising:
receiving input data corresponding to classes; and
determining a value of a parameter for a DSP component based on the input data, wherein the DSP component controls digital signal processing of the input data to generate features for a machine learning model to identify the classes, and wherein the value is determined from a set of candidate values based on applying an optimization function associated with the parameter.

17. The non-transitory computer readable medium storing instructions of claim 16, wherein the value corresponds to a candidate value of the set of candidate values that maximizes the optimization function.

18. The non-transitory computer readable medium storing instructions of claim 16, wherein the optimization function compares spectral energies at multiple frequencies as calculated by a DSP function implemented by the DSP component.

19. The non-transitory computer readable medium storing instructions of claim 16, the operations further comprising:
applying a penalty factor to the optimization function, wherein the penalty factor favors a first candidate value associated with a lesser consumption of resources of a target device and disfavors a second candidate value associated with a greater consumption of resources of the target device.

20. The non-transitory computer readable medium storing instructions of claim 16, the operations further comprising:
receiving an input indicating a microcontroller; and
eliminating a candidate value of the set of candidate values based on the input indicating the microcontroller.
